(19) United States
(12) Patent Application Publication
(10) Pub. No.: US 2012/0113827 A1
(43) Pub. Date: May 10, 2012

(54) DYNAMIC SIMULTANEOUS PUCCH AND PUSCH SWITCHING FOR LTE-A

(75) Inventors: Shohei Yamada, Camas, WA (US); Zhanping Yin, Vancouver, WA (US)

(73) Assignee: Sharp Laboratories of America, Inc., Camas, WA (US)

(21) Appl. No.: 12/941,927

(22) Filed: Nov. 8, 2010

(51) Int. Cl. H04W 24/00

(52) U.S. Cl. 370/252

(57) ABSTRACT

A method for reporting uplink control information (UCI) on a user equipment (UE) is described. A set of physical downlink control channel (PDCCH) candidates on an activated serving cell are monitored. A PDCCH of a serving cell intended for the UE in a subframe is detected. A physical downlink shared channel (PDSCH) corresponding to the PDCCH in the same subframe is decoded. Transmission of the UCI for a subframe corresponding to the subframe in which the PDCCH was decoded is adjusted.

### TECHNICAL FIELD

The present invention relates generally to wireless communications and wireless communications-related technology. More specifically, the present invention relates to systems and methods for dynamic simultaneous physical uplink control channel (PUCCH) and physical uplink shared channel (PUSCH) switching for Long Term Evolution Advanced (LTE-A).

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of cells, each of which may be serviced by a base station. A base station may be a fixed station that communicates with mobile stations.

Various signal processing techniques may be used in wireless communication systems to improve efficiency and quality of wireless communication. One such technique may include using simultaneous physical uplink control channel (PUCCH) and physical uplink shared channel (PUSCH) transmissions. Benefits may be realized by switching between simultaneous physical uplink control channel (PUCCH) and physical uplink shared channel (PUSCH) transmissions and non-simultaneous physical uplink control channel (PUCCH) and physical uplink shared channel (PUSCH) transmissions.

### BRIEF DESCRIPTION OF THE DRAWINGS

FIG. 1 is a block diagram illustrating a wireless communication system using uplink control information (UCI) multiplexing;

FIG. 2 is a block diagram illustrating transmissions from a user equipment (UE) to an eNode B;

FIG. 3 is a block diagram illustrating the layers used by a user equipment (UE);

FIG. 4 is a flow diagram of a method for transmitting uplink control information (UCI);

FIG. 5 is a flow diagram of another method for transmitting uplink control information (UCI);

FIG. 6 is a block diagram illustrating multiple subframes of communications between a user equipment (UE) and an eNode B;

FIG. 7 is another block diagram illustrating multiple subframes of communications between a user equipment (UE) and an eNode B;

FIG. 8 is yet another block diagram illustrating multiple subframes for communications between a user equipment (UE) and an eNode B;

FIG. 9 is a flow diagram of a method for transmitting uplink control information (UCI) when there are multiple serving cells;

FIG. 10 is a block diagram illustrating multiple subframes of communications between a user equipment (UE) and an eNode B when there are multiple serving cells;

FIG. 11 is another block diagram illustrating multiple subframes of communications between a user equipment (UE) and an eNode B when there are multiple serving cells;

FIG. 12 is a flow diagram of a simplified method for transmitting uplink control information (UCI) when there are multiple serving cells that does not take search space into account;

FIG. 13 is a flow diagram of a simplified method for transmitting uplink control information (UCI) when there are multiple serving cells that does not take search space or an HARQ-ACK corresponding to the physical downlink shared channel (PDSCH) of a secondary cell (SCell) into account;

FIG. 14 is a flow diagram of another simplified method for transmitting uplink control information (UCI) when there are multiple serving cells that depends on whether PUSCH transmission is done on only one serving cell;

FIG. 15 illustrates various components that may be utilized in a user equipment (UE); and

FIG. 16 illustrates various components that may be utilized in an eNode B.

### DETAILED DESCRIPTION

A method for reporting uplink control information (UCI) on a user equipment (UE) is described. A set of physical downlink control channel (PDCCH) candidates are monitored on an activated serving cell. A PDCCH of a serving cell intended for the UE is detected in a subframe. A physical downlink shared channel (PDSCH) corresponding to the PDCCH is decoded in the same subframe. Transmission of the UCI is adjusted for a subframe corresponding to the subframe in which the PDCCH is decoded.

The PDCCH detected may have a downlink control information (DCI) Format of 1/1A/1B/1C/1D/2/2A/2B/2C. Adjusting transmission of the UCI may include switching between simultaneous physical uplink control channel (PUCCH) and physical uplink shared channel (PUSCH) transmissions and non-simultaneous PUCCH and PUSCH transmissions. Simultaneous PUCCH and PUSCH transmissions may be configured. It may be determined whether the UE is transmitting on the PUSCH for the subframe.

The UE may not be transmitting on the PUSCH for the subframe. The UCI may be transmitted on the PUCCH for the subframe. The UE may be transmitting on the PUSCH for the subframe. It may be determined whether a PDCCH with downlink control information (DCI) Format 0 was detected in a common search space. If a PDCCH with DCI Format 0 was detected in the common search space, the UCI may be transmitted on the PUSCH for the subframe. If a PDCCH with DCI Format 0 was not detected in the common search space, the UCI may be transmitted on the PUCCH for the subframe. If a PDCCH with DCI Format 0 was not detected in the common search space, the UCI may be transmitted on the PUCCH and the PUSCH simultaneously for the subframe.

The UE may be monitoring a set of PDCCH candidates on multiple serving cells. Determining whether the UE is transmitting on the PUSCH for the subframe may include determining whether the UE is transmitting on the PUSCH for the subframe. If the UE is not transmitting on the PUSCH for the subframe, the UCI may be transmitted on the PUCCH for the subframe. If the UE is transmitting on the PUSCH for the subframe, the UCI may be transmitted on the PUCCH and the PUSCH simultaneously for the subframe.

If the UE is not transmitting on the PUSCH for the subframe, it may be determined whether a PDCCH with downlink control information (DCI) Format 0 was detected in a common search space. If a PDCCH with DCI Format 0 was detected in the common search space, the UCI may be transmitted on the PUCCH for the subframe. If a PDCCH with DCI Format 0 was not detected in the common search space, it may be determined whether the UE is transmitting a hybrid automatic repeat request with discontinuous transmission (HARQ-ACK) corresponding to a physical downlink shared channel (PDSCH) on a secondary cell.

If the UE is transmitting an HARQ-ACK corresponding to the PDSCH on a secondary cell, the UCI may be transmitted on the PUCCH for the subframe. If the UE is not transmitting an HARQ-ACK corresponding to the PDSCH on a secondary cell, the UCI may be transmitted on the PUSCH for the subframe.

Determining whether the UE is transmitting on the PUSCH for the subframe may include determining whether the UE is transmitting on the PUSCH for the subframe. If the UE is not transmitting on the PUSCH for the subframe, it may be determined whether the UE is transmitting a hybrid automatic repeat request with discontinuous transmission (HARQ-ACK) corresponding to a physical downlink shared channel (PDSCH) on a secondary cell. If the UE is transmitting an HARQ-ACK corresponding to the PDSCH on a secondary cell, the UCI may be transmitted on the PUCCH for the subframe. If the UE is not transmitting an HARQ-ACK corresponding to the PDSCH on a secondary cell, the UCI may be transmitted on the PUSCH for the subframe.

Determining whether the UE is transmitting on the PUSCH for the subframe may include determining whether the UE is transmitting on the PUSCH for the subframe. If he UE is not transmitting on the PUSCH for the subframe, it may be determined whether the UE is transmitting on the PUSCH on a secondary cell. If the UE is transmitting on the PUSCH on a secondary cell, the UCI may be transmitted on the PUCCH for the subframe. If the UE is not transmitting on the PUSCH on a secondary cell, the UCI may be transmitted on the PUSCH for the subframe.

If the UE is not transmitting on the PUSCH for the subframe, it may be determined whether the UE is transmitting on the PUSCHs on more than one serving cell. If the UE is transmitting on the PUSCHs on more than one serving cell, the UCI may be transmitted on the PUCCH for the subframe. If the UE is not transmitting on the PUSCHs on more than one serving cell, the UCI may be transmitted on the PUSCH for the subframe.

A user equipment (UE) configured for reporting uplink control information (UCI) is also described. The UE includes a processor, memory in electronic communication with the processor and instructions stored in the memory. The instructions are executable by the processor to monitor a set of physical downlink control channel (PDCCH) candidates on an activated serving cell. The instructions are also executable by the processor to detect a PDCCH of a serving cell intended for the UE in a subframe. The instructions are further executable by the processor to decode a physical downlink shared channel (PDSCH) corresponding to the PDCCH in the same subframe. The instructions are also executable by the processor to adjust transmission of the UCI for a subframe corresponding to the subframe in which the PDCCH is decoded.

If simultaneous physical uplink control channel (PUCCH) and physical uplink shared channel (PUSCH) transmission is not configured, the uplink control information (UCI) in a subframe may be transmitted on the physical uplink control channel (PUCCH) using format 1/1a/1b or 2/2a/2b or 3 if the user equipment (UE) is not transmitting on the physical uplink shared channel (PUSCH) in the subframe; the uplink control information (UCI) may be transmitted on the physical uplink shared channel (PUSCH) if the user equipment (UE) is transmitting on the physical uplink shared channel (PUSCH) in the subframe.

If simultaneous physical uplink control channel (PUCCH) and physical uplink shared channel (PUSCH) is configured, uplink control information (UCI) in a subframe may be transmitted on the PUCCH using format 1/1a/1b or 2/2a/2b or 3 if the user equipment (UE) is not transmitting on the PUSCH in the subframe; the UCI may be transmitted on the PUCCH using format 1/1a/1b or 2/2a/2b or 3 and/or the PUSCH if the UE is transmitting on the PUSCH in the subframe and the UE is transmitting on the PUSCH that was indicated by a physical downlink control channel (PDCCH) with DCI Format 0 that was not detected in the common search space; the UCI may be transmitted on the PUSCH and may not be transmitted on the PUCCH if the UE is transmitting on the PUSCH in the subframe and the UE is transmitting on the PUSCH as indicated by a PDCCH with DCI Format 0 detected in the common search space. Aperiodic CQI/PMI/RI reports are always transmitted on the PUSCH.

The phrase “transmitting on the PUSCH as indicated by a PDCCH with DCI Format 0 detected in the common search space” may be interchangeable with the phrase “transmitting on the PUSCH as indicated by a PDCCH with DCI Format 0 detected in the common search space or re-transmitting on the corresponding PUSCH for a transport block as indicated by the PDCCH with DCI Format 0 detected in the common search space.”

If simultaneous PUCCH and PUSCH is configured, UCI in a subframe may be transmitted on the PUCCH using format 1/1a/1b or 2/2a/2b or 3 if the UE is not transmitting on the PUSCH in the subframe, the UCI may be transmitted on the PUCCH using format 1/1a/1b or 2/2a/2b or 3 and/or the PUSCH if the UE is transmitting on the PUSCH in the subframe and the UE is transmitting on the PUSCH that was indicated by a PDCCH with DCI Format 0 not detected in common search space, or if the UE is transmitting on the PUSCH in the subframe and the UE is transmitting on the PUSCH on a secondary cell, or if the UE is transmitting on the PUSCH in the subframe and the UE is transmitting an HARQ-ACK corresponding to the physical downlink shared channel (PDSCH) on a secondary cell; the UCI may be transmitted on the PUSCH and may not be transmitted on the PUCCH if the UE is transmitting on the PUSCH in the subframe and the UE is transmitting on the PUSCH that was indicated by a PDCCH with DCI Format 0 detected in the common search space, the UE is not transmitting on the PUSCH on a secondary cell and the UE is not transmitting an HARQ-ACK for the PDSCH on a secondary cell. Aperiodic CQI/PMI/RI reports are always transmitted on the PUSCH.

The statement “if the UE is transmitting on the PUSCH in the subframe and the UE is not transmitting on the PUSCH on a secondary cell” may be interchangeable with the statement “if the UE has detected only one PDCCH Format 0/4 to allocate the PUSCH on a PCell.”

The statement “if the UE is transmitting on the PUSCH in the subframe and the UE is not transmitting an HARQ-ACK corresponding to a PDSCH on secondary cell” may be interchangeable with the statement “if the UE has decoded the PDSCH only on the PCell in a subframe n corresponding to an HARQ-ACK transmission in the subframe n+k.”

If simultaneous PUCCH and PUSCH is configured, UCI in a subframe may be transmitted on the PUCCH using format 1/1a/1b or 2/2a/2b or 3 if the UE is not transmitting on the PUSCH in the subframe; the UCI may be transmitted on the PUCCH using format 1/1a/1b or 2/2a/2b or 3 and/or the PUSCH if the UE is transmitting on the PUSCH in the subframe and the UE is transmitting on the PUSCH on a secondary cell, or if the UE is transmitting on the PUSCH in the subframe and the UE is transmitting an HARQ-ACK corresponding to the physical downlink shared channel (PDSCH) on a secondary cell; the UCI may be transmitted on the PUSCH and may not be transmitted on the PUCCH if the UE is transmitting on the PUSCH in the subframe and the UE is not transmitting on the PUSCH on a secondary cell and the UE is not transmitting an HARQ-ACK for the PDSCH on a secondary cell. Aperiodic CQI/PMI/RI reports are always transmitted on the PUSCH.

If simultaneous PUCCH and PUSCH is configured, UCI in a subframe may be transmitted on the PUCCH using format 1/1a/1b or 2/2a/2b or 3 if the UE is not transmitting on the PUSCH in the subframe; the UCI may be transmitted on the PUCCH using format 1/1a/1b or 2/2a/2b or 3 and/or the PUSCH if the UE is transmitting on the PUSCH in the subframe and the UE is transmitting on the PUSCH on a secondary cell; the UCI may be transmitted on the PUSCH and may not be transmitted on the PUCCH if the UE is transmitting on the PUSCH in the subframe and the UE is not transmitting on the PUSCH on a secondary. Aperiodic CQI/PMI/RI reports are always transmitted on the PUSCH if simultaneous PUCCH and PUSCH is configured, UCI in a subframe may be transmitted on the PUCCH using format 1/1a/1b or 2/2a/2b or 3 if the UE is not transmitting on the PUSCH in the subframe; the UCI may be transmitted on the PUCCH using format 1/1a/1b or 2/2a/2b or 3 and/or the PUSCH if the UE is transmitting on the PUSCH in the subframe and the UE is transmitting on the PUSCHs on more than one serving cell; the UCI may be transmitted on the PUSCH and may not be transmitted on the PUCCH if the UE is transmitting on the PUSCH in the subframe and the UE is not transmitting on the PUSCHs on more than one serving cell. Aperiodic CQI/PMI/RI reports are always transmitted on the PUSCH.

The statement “if the UE is transmitting on the PUSCH in the subframe and the UE is not transmitting on the PUSCHs on more than one serving cell” may be interchangeable with the statement “if the UE has detected only one PDCCH Format 0/4 to allocate the PUSCH.”

The 3rd Generation Partnership Project, also referred to as “3GPP,” is a collaboration agreement that aims to define globally applicable technical specifications and technical reports for third and fourth generation wireless communication systems. The 3GPP may define specifications for the next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE and LTE-Advanced standards (e.g., Release-8, Release-9 and Release-10). However, the scope of the present disclosure should not be limited in this regard. At least some aspects of the systems and methods disclosed herein may be utilized in other types of wireless communication systems.

The term “simultaneous” may be used herein to denote a situation where two or more events occur in overlapping time frames. In other words, two “simultaneous” events may overlap in time to some extent, but are not necessarily of the same duration. Furthermore, simultaneous events may or may not begin or end at the same time.

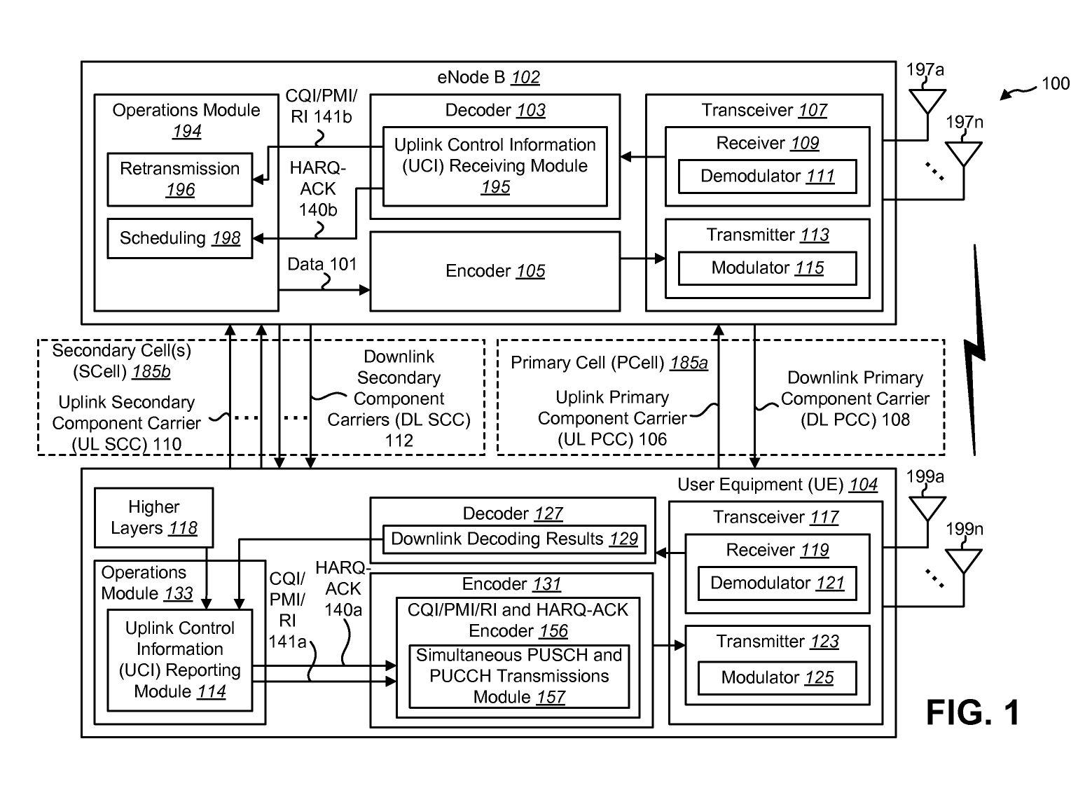

FIG. 1 is a block diagram illustrating a wireless communication system 100 using uplink control information (UCI) multiplexing. An eNode B 102 may be in wireless communication with one or more user equipments (UEs) 104. An eNode B 102 may be referred to as an access point, a Node B, a base station or some other terminology. Likewise, a user equipment (UE) 104 may be referred to as a mobile station, a subscriber station, an access terminal, a remote station, a user terminal, a terminal, a handset, a subscriber unit, a wireless communication device, or some other terminology.

Communication between a user equipment (UE) 104 and an eNode B 102 may be accomplished using transmissions over a wireless link, including an uplink and a downlink. The uplink refers to communications sent from a user equipment (UE) 104 to an eNode B 102. The downlink refers to communications sent from an eNode B 102 to a user equipment (UE) 104. The communication link may be established using a single-input and single-output (SISO), multiple-input and single-output (MISO) or a multiple-input and multiple-output (MIMO) system. A MIMO system may include both a transmitter and a receiver equipped with multiple transmit and receive antennas. Thus, an eNode B 102 may have multiple antennas and a user equipment (UE) 104 may have multiple antennas. In this way, the eNode B 102 and the user equipment (UE) 104 may each operate as either a transmitter or a receiver in a MIMO system. One benefit of a MIMO system is improved performance if the additional dimensionalities created by the multiple transmit and receive antennas are utilized.

The user equipment (UE) 104 communicates with an eNode B 102 using one or more antennas 199a-n. The user equipment (UE) 104 may include a transceiver 117, a decoder 127, an encoder 131 and an operations module 133. The transceiver 117 may include a receiver 119 and a transmitter 123. The receiver 119 may receive signals from the eNode B 102 using one or more antennas 199a-n. For example, the receiver 119 may receive and demodulate received signals using a demodulator 121. The transmitter 123 may transmit signals to the eNode B 102 using one or more antennas 199a-n. For example, the transmitter 123 may modulate signals using a modulator 125 and transmit the modulated signals.

The receiver 119 may provide a demodulated signal to the decoder 127. The user equipment (UE) 104 may use the decoder 127 to decode signals and make downlink decoding results 129. The downlink decoding results 129 may indicate whether data was received correctly. For example, the downlink decoding results 129 may indicate whether a packet was correctly or erroneously received (i.e., positive acknowledgement, negative acknowledgement or discontinuous transmission (no signal)).

The operations module 133 may be a software and/or hardware module used to control user equipment (UE) 104 communications. For example, the operations module 133 may determine when the user equipment (UE) 104 requires resources to communicate with an eNode B 102.

In 3^{rd} Generation Partnership Project (3GPP) Long Term Evolution (LTE)—Advanced, additional control feedback will have to be sent on control channels to accommodate MIMO and carrier aggregation (CA). Carrier aggregation refers to transmitting data on multiple component carriers (CC) that are contiguously or separately located. Both the hybrid automatic repeat and request (ARQ) acknowledgement (HARQ-ACK) with positive-acknowledge and negative-acknowledge (ACK/NACK) bits and other control information may be transmitted using the physical uplink control channel (PUCCH).

The user equipment (UE) 104 may transmit uplink control information (UCI) to an eNode B 102 on the uplink. The uplink control information (UCI) may include a channel quality indicator (CQI), a precoding matrix index (PMI), rank indication (RI), a scheduling request (SR) and a hybrid automatic repeat request acknowledgement (HARQ-ACK) 140a. HARQ-ACK 140a means ACK (positive-acknowledgement) and/or NACK (negative-acknowledgement) and/or DTX (discontinuous transmission) responses for HARQ operation, also known as ACK/NACK. In one configuration, the CQI/PMI/RI 141a and the HARQ-ACK 140a may be separately coded. In another configuration, the CQI/PMI/RI 141a and the HARQ-ACK 140a may be jointly coded. Herein, CQI/PMI/RI 141 refers to CQI and/or PMI and/or RI. CQI/PMI/RI 141 may also be referred to as channel state information (CSI). The CQI and/or PMI and/or RI may be reported together or independently based on the physical uplink control channel (PUCCH) reporting modes. ACK/NACK refers to ACK and/or NACK. CQI/PMI/RI 141 and HARQ-ACK 140 refers to ((CQI and/or PMI and/or RI) AND HARQ-ACK 140). CQI/PMI/RI 141 or HARQ-ACK refers to ((CQI and/or PMI and/or RI) OR HARQ-ACK 140).

The CQI/PMI/RI 141a and the HARQ-ACK 140a may be generated by the uplink control information (UCI) reporting module 114 and transferred to a CQI/PMI/RI and HARQ-ACK encoder 156 that is part of the encoder 131. The CQI/PMI/RI and HARQ-ACK encoder 156 may generate uplink control information (UCI) using backwards compatible physical uplink control channel (PUCCH) formats and physical uplink shared channel (PUSCH) formats. Backwards compatible physical uplink control channel (PUCCH) formats are those formats that may be used by Release-10 user equipments (UEs) 104 as well as Release-8/9 user equipments (UEs) 104.

The CQI/PMI/RI and HARQ-ACK encoder 156 may include a simultaneous physical uplink control channel (PUCCH) and physical uplink shared channel (PUSCH) transmissions module 157. In 3GPP LTE Release 10 (LTE-A or Advanced EUTRAN), simultaneous physical uplink shared channel (PUSCH) and physical uplink control channel (PUCCH) transmission is introduced. The use of simultaneous physical uplink shared channel (PUSCH) and physical uplink control channel (PUCCH) transmissions may be configured by the radio resource control (RRC) configuration based on user equipment (UE) 104 specific RRC signaling. When a user equipment (UE) 104 that is configured for simultaneous physical uplink shared channel (PUSCH) and physical uplink control channel (PUCCH) transmission is allocated or assigned both the physical uplink shared channel (PUSCH) and the physical uplink control channel (PUCCH) on a subframe or when the user equipment (UE) 104 is required to transmit on both the physical uplink shared channel (PUSCH) and the physical uplink control channel (PUCCH) on a subframe, the user equipment (UE) 104 may transmit on the physical uplink shared channel (PUSCH) and the physical uplink control channel (PUCCH) simultaneously.

However, an eNode B 102 may want to enforce a Release 10 user equipment (UE) 104 to not simultaneously transmit on the physical uplink shared channel (PUSCH) and the physical uplink control channel (PUCCH) during some situations. For example, when a user equipment (UE) 104 is in a transition state during RRC configuration, when the power of the user equipment (UE) 104 is not enough to transmit both the physical uplink control channel (PUCCH) and the physical uplink shared channel (PUSCH) or when a scheduler on the eNode B 102 does not want to allocate the physical uplink control channel (PUCCH) resource to the user equipment (UE) 104 for a subframe, it may be desirable that the user equipment (UE) 104 does not simultaneously transmit both the physical uplink shared channel (PUSCH) and the physical uplink control channel (PUCCH). The user equipment (UE) 104 may use the simultaneous physical uplink shared channel (PUSCH) and physical uplink control channel (PUCCH) transmissions module 157 to dynamically switch between simultaneous physical uplink shared channel (PUSCH) and physical uplink control channel (PUCCH) transmission and non-simultaneous physical uplink shared channel (PUSCH) and physical uplink control channel (PUCCH) transmissions.

Thus, one benefit of using a procedure/mechanism where simultaneous physical uplink shared channel (PUSCH) and physical uplink control channel (PUCCH) transmission may be used in a normal case and non-simultaneous physical uplink shared channel (PUSCH) and physical uplink control channel (PUCCH) transmissions may be used in a special case is that it is possible to dynamically switch between simultaneous physical uplink shared channel (PUSCH) and physical uplink control channel (PUCCH) transmission and non-simultaneous physical uplink shared channel (PUSCH) and physical uplink control channel (PUCCH) transmissions even if it is under the configuration which allows simultaneous physical uplink shared channel (PUSCH) and physical uplink control channel (PUCCH) transmission. This allows the eNode B 102 greater flexibility in assigning time/frequency resources to user equipments (UEs) 104.

In LTE Release-8/9, physical uplink control channel (PUCCH) Format 1/1a/1b may be used to report the HARQ-ACK 140a and physical uplink control channel (PUCCH) Format 2 may be used to report periodic CQI/PMI/RI 141a. When a collision between periodic CQI/PMI/RI 141a and HARQ-ACK 140a reporting on the physical uplink control channel (PUCCH) occurs, Format 2 with joint coding for extended cyclic prefix (CP) or Format 2a/2b for normal cyclic prefix (CP) can be used to report the CQI/PMI/RI 141a and the HARQ-ACK 140a simultaneously.

To report the HARQ-ACK 140 on the physical uplink control channel (PUCCH), for Release-10 user equipments (UEs) 104 that support up to four HARQ-ACK 140 bits, physical uplink control channel (PUCCH) Format 1a/1b with channel selection may be used. Since the new Format 3 is not supported by these user equipments (UEs) 104, a backward compatible physical uplink control channel (PUCCH) format may be reused.

For Release-10 user equipments (UEs) 104 that support more than four HARQ-ACK 140 bits, physical uplink control channel (PUCCH) Format 1a/1b can also be used for up to four bits of HARQ-ACK 140 reporting. Thus, the backward compatible physical uplink control channel (PUCCH) format may also be used.

A new DFT-S-OFDM based Format 3 can be used for Release-10 user equipments (UEs) 104 that support more than four HARQ-ACK 140 bits, regardless of the actual HARQ-ACK 140 payload sizes. Because of cubic metric issues, only one physical uplink control channel (PUCCH) signal may be transmitted at any given time interval (or transmission time interval (TTI)). With simultaneous CQI/PMI/RI 141 and HARQ-ACK 140 reporting, a backward compatible physical uplink control channel (PUCCH) Format 2/2a/2b based method or a method for simultaneous reporting using the new Format 3 may be used.

The user equipment (UE) 104 may also transmit a reference signal (RS) to an eNode B 102. The uplink control information (UCI) may be transmitted using the physical uplink control channel (PUCCH) and/or the physical uplink shared channel (PUSCH). One or more physical uplink control channel (PUCCH) reference signal (RS) symbols are included in a physical uplink control channel (PUCCH) signal transmission on each slot.

In LTE Release-8, only one uplink component carrier (CC) and one downlink component carrier (CC) can be used for each user equipment (UE) 104. The uplink control information (UCI) such as ACK/NACK bits for hybrid ARQ (HARQ) 140a and periodic channel quality indicators (Cal), precoding matrix index (PMI) and rank indication (RI) can be sent on the physical uplink control channel (PUCCH), on the physical uplink shared channel (PUSCH) or on both. In one configuration, there may be a first uplink control information (UCI) that is scheduled on the physical uplink control channel (PUCCH) and a second uplink control information (UCI) that is scheduled on the physical uplink shared channel (PUSCH). In some conditions, for example in cases where a collision between the physical uplink control channel (PUCCH) and the physical uplink shared channel (PUSCH) occurs, the uplink control information (UCI) that is scheduled on the physical uplink control channel (PUCCH) may be transmitted on the physical uplink shared channel (PUSCH).

The physical uplink control channel (PUCCH) may occupy one resource block (RB) at each slot. Thus, a very limited amount of information can be transmitted on the physical uplink control channel (PUCCH). With physical uplink control channel (PUCCH) Format 1/1a/1b, only one or two ACK/NACK bits are transmitted. With physical uplink control channel (PUCCH) Format 2/2a/2b, one or two ACK/NACK bits can be simultaneously transmitted with four to eleven bits of CQI/PMI/RI 141. Thus, the maximum payload size that can be carried on a Release-8 physical uplink control channel (PUCCH) is thirteen bits.

Format 1a may be used for a one bit HARQ-ACK 140. Format 1a may also be used for a one bit HARQ-ACK 140 with positive scheduling request (SR) in frequency division duplexing (FDD). Format 1b may be used for a two bit HARQ-ACK 140 or for a two bit HARQ-ACK 140 with a positive scheduling request (SR). Format 1b may also be used for an HARQ-ACK 140 with channel selection. Format 1 may be used for a positive scheduling request (SR).

Format 2 may be used for a CQI/PMI/RI report when the CQI/PMI/RI report is not multiplexed with the HARQ-ACK 140. Format 2 may also be used for a CQI/PMI/RI report when the CQI/PMI/RI report is multiplexed with the HARQ-ACK 140 for extended cyclic prefix. Format 2a may be used for a CQI/PMI/RI report that is multiplexed with a one bit HARQ-ACK 140 for normal cyclic prefix. Format 2b may be used for a CQI/PMI/RI report that is multiplexed with a two bit HARQ-ACK 140 for normal cyclic prefix. The problem is how to multiplex the CQI/PMI/RI 141 and more than two bits of HARQ-ACK 140 for carrier aggregation.

In 3GPP Long Term Evolution (LTE) Release 10 (LTE-A or Advanced EUTRAN), carrier aggregation was introduced. Carrier aggregation may also be referred to as cell aggregation. Carrier aggregation is supported in both the uplink and the downlink with up to five component carriers, also known as cells. Each component carrier or cell may have a transmission bandwidth of up to 110 resource blocks. In carrier aggregation, two or more component carriers or cells are aggregated to support wider transmission bandwidths up to 100 megahertz (MHz). A user equipment (UE) 104 may simultaneously receive or transmit one or multiple component carriers or cells, depending on the capabilities of the user equipment (UE) 104.

Based on current agreements, cyclic CQI/PMI/RI 141 reporting of each component carrier is supported in Release-10. Thus, the same CQI/PMI/RI payload as in Release 8 can be used. Therefore, a Format 2 based physical uplink control channel (PUCCH) may be reused for periodic CQI/PMI/RI 141 reporting of each component carrier or cell.

For LTE Release-10 and beyond, in case of a collision between a CQI/PMI/RI 141 and an HARQ-ACK 140 in the same subframe on the physical uplink control channel (PUCCH), the CQI/PMI/RI 141 may be dropped as in Release 8/9. Because LTE Release-10 and beyond has multiple component carriers or cells using cyclic CQI/PMI/RI 141 reporting, the interval between the next reporting of the same component carrier or cell may be longer than that of Release-8/9. Dropping a CQI/PMI/RI 141 may cause poor channel estimation. Therefore, a method for the simultaneous reporting of CQI/PMI/RI 141 and HARQ-ACK 140 should be supported in Release-10.

A user equipment (UE) 104 may communicate with an eNode B 102 using multiple cells 185 at the same time. For example, a user equipment (UE) 104 may communicate with an eNode B 102 using a primary cell (PCell) 185a while simultaneously communicating with the eNode B 102 using secondary cells (SCell) 185b.

An eNode B 102 may include a transceiver 107 that includes a receiver 109 and a transmitter 113. An eNode B 102 may additionally include a decoder 103, an encoder 105 and an operations module 194. An eNode B 102 may receive uplink control information (UCI) using its one or more antennas 197a-n and its receiver 109. The receiver 109 may use the demodulator 111 to demodulate the uplink control information (UCI).

The decoder 103 may include an uplink control information (UCI) receiving module 195. An eNode B 102 may use the uplink control information (UCI) receiving module 195 to decode and interpret the uplink control information (UCI) received by the eNode B 102. The eNode B 102 may use the decoded uplink control information (UCI) to perform certain operations, such as retransmit one or more packets based or schedule communication resources for the user equipment (UE) 104. The uplink control information (UCI) may include a CQI/PMI/RI 141b and/or an HARQ-ACK 140b.

The operations module 194 may include a retransmission module 196 and a scheduling module 198. The retransmission module 196 may determine which packets to retransmit (if any) based on the uplink control information (UCI). The scheduling module 198 may be used by the eNode B 102 to schedule communication resources (e.g., bandwidth, time slots, frequency channels, spatial channels, etc.). The scheduling module 198 may use the uplink control information (UCI) to determine whether (and when) to schedule communication resources for the user equipment (UE) 104.

The operations module 194 may provide data 101 to the encoder 105. For example, the data 101 may include packets for retransmission and/or a scheduling grant for the user equipment (UE) 104. The encoder 105 may encode the data 101, which may then be provided to the transmitter 113. The transmitter 113 may modulate the encoded data using the modulator 115. The transmitter 113 may transmit the modulated data to the user equipment (UE) 104 using one or more antennas 197a-n.

When carrier aggregation is configured, a user equipment (UE) 104 may have only one Radio Resource Control (RRC) connection with the network. At the RRC connection establishment/re-establishment/handover, one serving cell (i.e., the primary cell (PCell) 185a) provides the non-access stratum (NAS) mobility information (e.g., Tracking Area Identity (TAI)) and the security input.

In the downlink, the carrier corresponding to the primary cell (PCell) 185a is the downlink primary component carrier (DL PCC) 108. In the uplink, the carrier corresponding to the primary cell (PCell) 185a is the uplink primary component carrier (UL PCC) 106. Depending on the capabilities of the user equipment (UE) 104, one or more secondary component carriers (SCC) or secondary cells (SCell) 185b may be configured to form a set of serving cells with the primary cell (PCell) 185a. In the downlink, the carrier corresponding to the secondary cell (SCell) 185b is the downlink secondary component carrier (DL SCC) 112. In the uplink, the carrier corresponding to the secondary cell (SCell) 185b is the uplink secondary component carrier (UL SCC) 110. The number of downlink component carriers 108, 112 may be different from the number of uplink component carriers 106, 110 because multiple cells may share one uplink component carrier.

If carrier aggregation is configured, a user equipment (UE) 104 may have multiple serving cells: a primary cell (PCell) 185a and one or more secondary cells (SCell) 185b. From a network perspective, the same serving cell may be used as the primary cell (PCell) 185a by one user equipment (UE) 104 and used as a secondary cell (SCell) 185b by another user equipment (UE) 104. A primary cell (PCell) 185a that is operating according to Release-8/9 is equivalent to the Release-8/9 serving cell. When operating according to Release-10, there may be one or more secondary cells (SCell) 185b in addition to the primary cell (PCell) 185a if carrier aggregation is configured.

A number of spatial channels may be available on each serving cell by using multiple antennas at a transmitter and a receiver. Therefore, multiple codewords (up to two codewords) may be transmitted simultaneously. If the user equipment (UE) 104 is configured with five component carriers and two codewords for each of the component carriers, ten HARQ-ACK 140 acknowledgement/negative acknowledgement (ACK/NACK) bits for a single downlink subframe may be generated by the user equipment (UE) 104 for a single uplink subframe. One benefit of using carrier aggregation is that additional downlink and/or uplink data may be transmitted.

It has been agreed that for periodic CQI/PMI/RI 141 reporting for carrier aggregation, the configuration of different (in time) physical uplink control channel (PUCCH) resources for reports for each component carrier (CC) is supported. It has also been agreed that for Release-10 user equipments (UEs) 104 that support up to four HARQ-ACK 140 bits, physical uplink control channel (PUCCH) Format 1b with channel selection should be used. For Release-10 user equipments (UEs) 104 that support more than four HARQ-ACK 140 bits, physical uplink control channel (PUCCH) Format 1b with channel selection can be used for up to four HARQ-ACK bits. Format 3 is supported for all HARQ-ACK 140 bit ranges. Format 3 is a new format for LTE-A, which can carry 48 coded bits. Format 3 is based on a discrete Fourier Transform spread orthogonal frequency division multiplexing (DFT-S-OFDM) structure.

In Release-8/9, the maximum number of bits for HARQ-ACK 140 is two bits for frequency division duplexing (FDD) using Format 1b or Format 2/2b and four bits for time division duplexing (TDD) using Format 1b with channel selection. For frequency division duplexing (FDD), a user equipment (UE) 104 may determine the number of configured serving cells and the downlink transmission modes configured for each serving cell. A user equipment (UE) 104 may use two HARQ-ACK 140 bits for a serving cell configured with a downlink transmission mode that supports up to two transport blocks (codewords), and one HARQ-ACK 140 bit otherwise. A user equipment (UE) 104 that supports more than four ACK/NACK bits may be configured by higher layer 118 signaling to use either physical uplink control channel (PUCCH) Format 1a/1b with channel selection or physical uplink control channel (PUCCH) Format 3 for transmission of the HARQ-ACK 140.

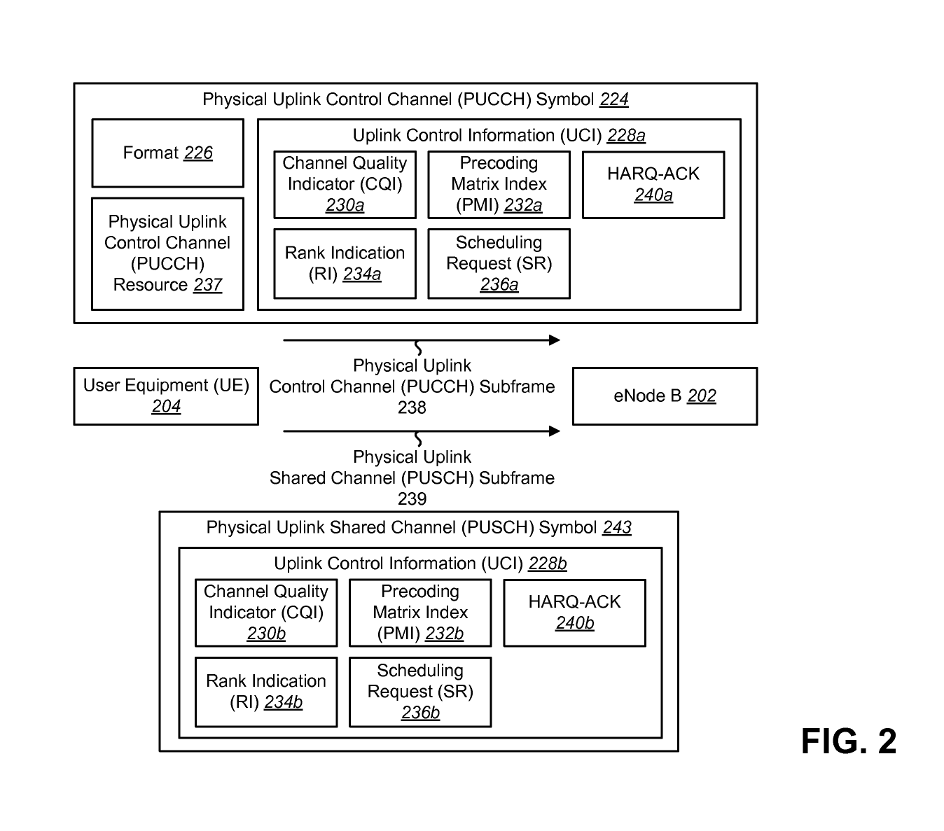

FIG. 2 is a block diagram illustrating transmissions from a user equipment (UE) 204 to an eNode B 202. The user equipment (UE) 204 may transmit a physical uplink control channel (PUCCH) symbol 224 via a physical uplink control channel (PUCCH) subframe 238 to the eNode B 202. The user equipment (UE) 204 may also transmit a physical uplink shared channel (PUSCH) symbol 243 via a physical uplink shared channel (PUSCH) subframe 239 to the eNode B 202. In one configuration, the user equipment (UE) 204 may simultaneously transmit a physical uplink control channel (PUCCH) symbol 224 and a physical uplink shared channel (PUSCH) symbol 243 to the eNode B 202.

The physical uplink control channel (PUCCH) symbol 224 may include uplink control information (UCI) 228a. The uplink channel information (UCI) 228a may include a channel quality indicator (CQI) 230a, a precoding matrix index (PMI) 232a, a rank indication (RI) 234a, a scheduling request (SR) 236a and/or an HARQ-ACK 240a. The CQI/PMI/RI 141 may be scheduled on the physical uplink control channel (PUCCH) periodically by higher layer 118 signaling. The physical uplink control channel (PUCCH) may be sent only on the primary cell (PCell) 185a. The HARQ-ACK 240a is generated dynamically based on the detection of a physical downlink shared channel (PDSCH). A collision may occur between a CQI/PMI/RI 141 and an HARQ-ACK 240a in the same subframe.

The physical uplink control channel (PUCCH) symbol 224 may further include a format 226 for which the physical uplink control channel (PUCCH) symbol 224 was transmitted. For example, the physical uplink control channel (PUCCH) symbol 224 may be transmitted using Format 1/1a/1b, Format 2/2a/2b, Format 3 or any other new formats. As used herein, Format 1/1 a/1b represents Format 1 and/or Format 1a and/or Format 1b. Also, as used herein, Format 2/2a/2b represents Format 2 and/or Format 2a and/or Format 2b. The physical uplink control channel (PUCCH) symbol 224 may also include a physical uplink control channel (PUCCH) resource 237. The physical uplink control channel (PUCCH) resource 237 for the CQI/PMI/RI 141 may be periodically pre-assigned by a higher layer 118, which uses Format 2/2a/2b. The eNode B 202 may dynamically allocate the physical downlink shared channel (PDSCH); the HARQ-ACK 240a is then dynamically generated in a subframe. Therefore, sometimes the CQI/PMI/RI 141 may collide with the HARQ-ACK 240a in the same subframe.

To avoid dropping one of them in collisions between a CQI/PMI/RI 141 and an HARQ-ACK 240a, the CQI/PMI/RI 141 may be multiplexed with the HARQ-ACK 240a on the physical uplink control channel (PUCCH). This is because of the single carrier property for uplink in an LTE system (i.e., a user equipment (UE) 204 should not transmit multiple channels simultaneously on one component carrier). Format 3 may be used for multiplexing the CQI/PMI/RI 141 with the HARQ-ACK 240a. If the CQI/PMI/RI 141 and the HARQ-ACK 240a are not multiplexed, the CQI/PMI/RI 141 may be dropped by the user equipment (UE) 204. Thus, one benefit of using Format 3 is that the CQI/PMI/RI 141 may be multiplexed with the HARQ-ACK 240a, allowing for the uplink transmission of additional data.

A user equipment (UE) 204 that supports up to four ACK/NACK bits can use physical uplink control channel (PUCCH) Format 1a/1b with channel selection for transmission of the HARQ-ACK 240a. A user equipment (UE) 204 that supports more than four ACK/NACK bits is configured by higher layer 118 signaling to use either physical uplink control channel (PUCCH) Format 1a/1b with channel selection or physical uplink control channel (PUCCH) Format 3 for transmission of the HARQ-ACK 240a. A user equipment (UE) 204 may determine the number of HARQ-ACK 240a bits based on the number of configured serving cells and the downlink transmission modes configured for each serving cell. A user equipment (UE) 204 may use two HARQ-ACK 240a bits for a serving cell configured with a downlink transmission mode that supports up to two transport blocks and one HARQ-ACK 240a bit otherwise.

For physical uplink control channel (PUCCH) Format 3, a user equipment (UE) 204 may transmit a NACK for a DTX HARQ-ACK 240a response for a transport block associated with a configured serving cell. DTX means that the user equipment (UE) 204 has missed the downlink assignment.

The physical uplink shared channel (PUSCH) symbol 243 may also include uplink control information (UCI) 228b. The uplink channel information (UCI) 228b may include a channel quality indicator (CQI) 230b, a precoding matrix index (PMI) 232b, a rank indication (RI) 234b, a scheduling request (SR) 236b and/or an HARQ-ACK 240b. The physical uplink shared channel (PUSCH) may be sent on the primary cell (PCell) 185a and/or on one or more secondary cells (SCell) 185b. The HARQ-ACK 240 is generated dynamically based on the detection of a physical downlink shared channel (PDSCH).

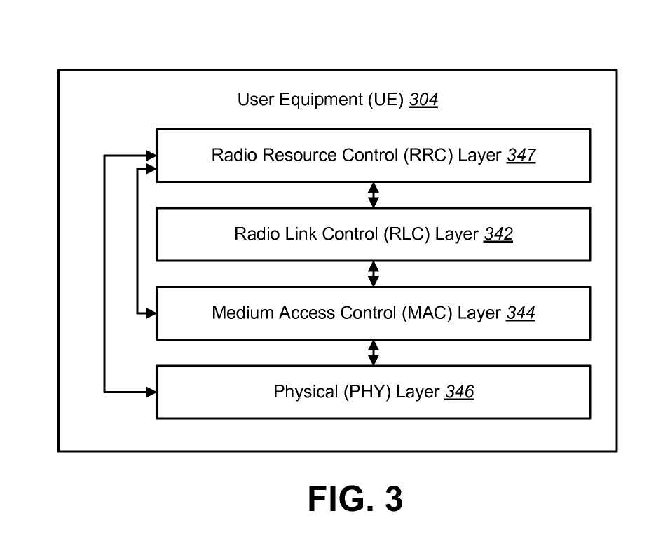

FIG. 3 is a block diagram illustrating the layers used by a user equipment (UE) 304. The user equipment (UE) 304 of FIG. 3 may be one configuration of the user equipment (UE) 104 of FIG. 1. The user equipment (UE) 304 may include a radio resource control (RRC) layer 347, a radio link control (RLC) layer 342, a medium access control (MAC) layer 344 and a physical (PHY) layer 346. These layers may be referred to as higher layers 118. The user equipment (UE) 304 may include additional layers not shown in FIG. 3.

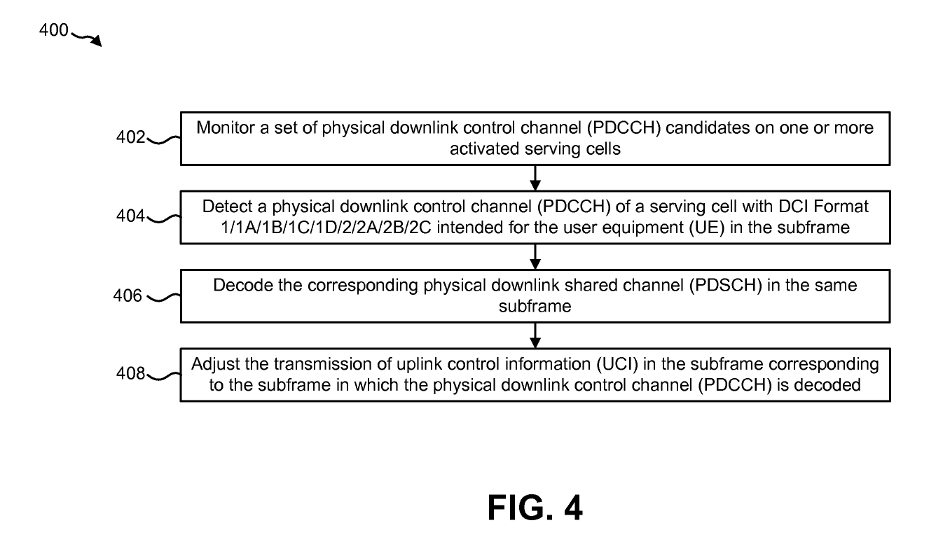

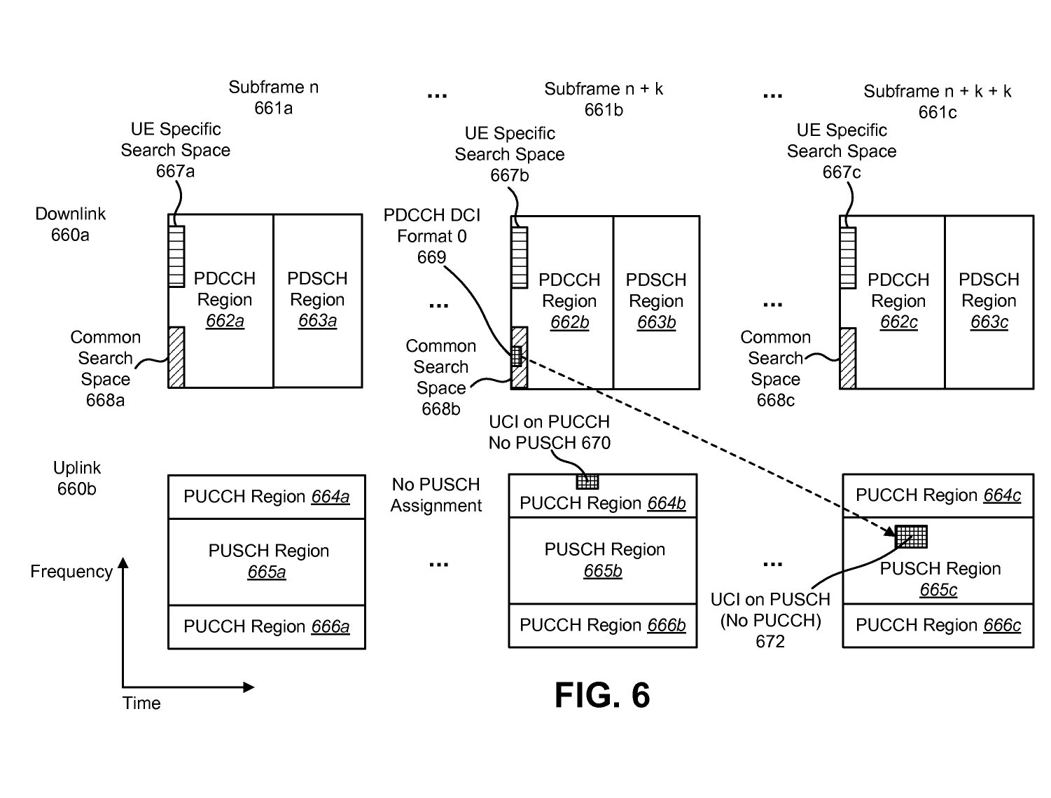

FIG. 4 is a flow diagram of a method 400 for transmitting uplink control information (UCI) 228. The method 400 may be performed by a user equipment (UE) 104. The user equipment (UE) 104 may monitor 402 a set of physical downlink control channel (PDCCH) candidates on one or more activated serving cells 185. In one configuration, the user equipment (UE) 104 may monitor 402 a set of physical downlink control channel (PDCCH) candidates on one or more activated serving cells 185 as configured by higher layer 118 signaling for control information. More than one serving cell 185 may be configured by the radio resource control (RRC) and a serving cell 185 may be activated or deactivated by the medium access control (MAC) layer 344. The set of physical downlink control channel (PDCCH) candidates to monitor may be defined in terms of search spaces. The primary cell (PCell) 185a may have both a common search space and a UE specific search space. A secondary cell (SCell) 185b may have a UE specific search space. The UE specific search space is defined by the Cell Radio Network Temporary Identifier (C-RNTI ((UEID)) and is prepared for each serving cell 185. The UE specific search space is discussed in additional detail below in relation to FIG. 6.

There are several physical downlink control channel (PDCCH) downlink control information (DCI) formats. The user equipment (UE) 104 may detect 404 a physical downlink control channel (PDCCH) of a serving cell 185 intended for the user equipment (UE) 104 in a subframe. In one configuration, the physical downlink control channel (PDCCH) detected may be a physical downlink control channel (PDCCH) with a DCI Format of 1/1A/1B/1C/1D/2/2A/2B/2C. The user equipment (UE) 104 may decode 406 the corresponding physical downlink shared channel (PDSCH) in the same subframe. The user equipment (UE) 104 may then adjust 408 the transmission of uplink control information (UCI) in the subframe corresponding to the subframe in which the physical downlink control channel (PDCCH) is decoded. The transmission of uplink control information (UCI) 228 may be in the physical uplink shared channel (PUSCH), the physical uplink control channel (PUCCH) or both the physical uplink shared channel (PUSCH) and the physical uplink control channel (PUCCH) simultaneously.

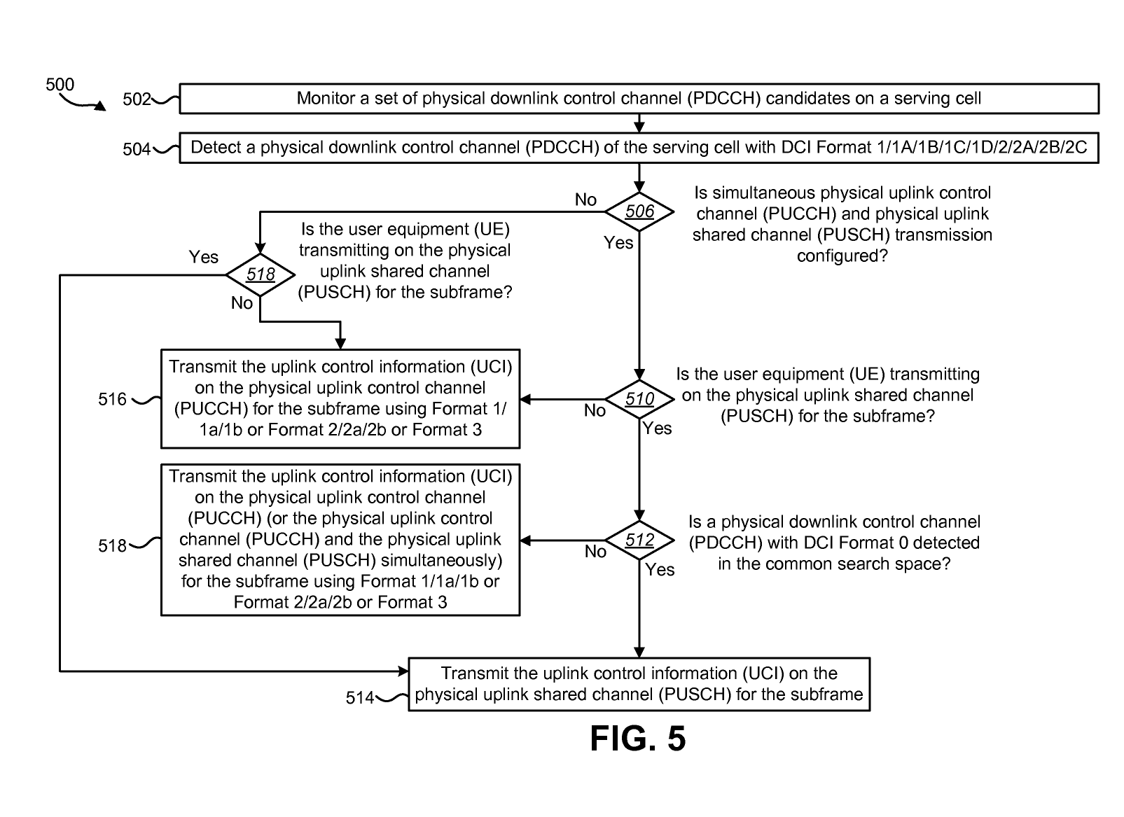

FIG. 5 is a flow diagram of another method 500 for transmitting uplink control information (UCI) 228. The method 500 may be performed by a user equipment (UE) 104. The user equipment (UE) 104 may monitor 502 a set of physical downlink control channel (PDCCH) candidates on a serving cell 185. The user equipment (UE) 104 may detect 504 a physical downlink control channel (PDCCH) of the serving cell with DCI Format 1/1A/1B/1C/1D/2/2A/2B/2C. The user equipment (UE) 104 may then determine 506 whether simultaneous physical uplink control channel (PUCCH) and physical uplink shared channel (PUSCH) transmission is configured for the user equipment (UE) 104.

The use of simultaneous physical uplink shared channel (PUSCH) and physical uplink control channel (PUCCH) transmissions may be configured by the radio resource control (RRC) configuration based on user equipment (UE) 104 specific RRC signaling. For example, if a parameter SimultaneousPUCCHandPUSCH on the user equipment (UE) 104 is set to TRUE, simultaneous physical uplink shared channel (PUSCH) and physical uplink control channel (PUCCH) transmissions may be configured (i.e., be allowed); otherwise, simultaneous physical uplink shared channel (PUSCH) and physical uplink control channel (PUCCH) transmissions may not be configured (i.e., not be allowed).

If simultaneous physical uplink control channel (PUCCH) and physical uplink shared channel (PUSCH) transmission is configured for the user equipment (UE) 104, the user equipment (UE) 104 may determine 510 whether the user equipment (UE) 104 is transmitting on the physical uplink shared channel (PUSCH) for the subframe. If the user equipment (UE) 104 is not transmitting on the physical uplink shared channel (PUSCH) for the subframe, the user equipment (UE) 104 may transmit 516 the uplink control information (UCI) 228 on the physical uplink control channel (PUCCH) for the subframe using Format 1/1a/1b or Format 2/2a/2b or Format 3.

If the user equipment (UE) 104 is transmitting on the physical uplink shared channel (PUSCH) for the subframe, the user equipment (UE) 104 may determine 512 whether a physical downlink control channel (PDCCH) with downlink control information (DCI) Format 0 was detected in the common search space. The common search space is discussed in further detail below in relation to FIG. 6. If the physical downlink control channel (PDCCH) with downlink control information (DCI) Format 0 was detected in the common search space, the user equipment (UE) 104 may transmit 514 the uplink control information (UCI) 228 on the physical uplink shared channel (PUSCH) for the subframe. If the physical downlink control channel (PDCCH) with downlink control information (DCI) Format 0 was not detected in the common search space (and thus was either detected in the UE specific search space or another downlink control information (DCI) format was detected), the user equipment (UE) 104 may transmit 518 the uplink control information (UCI) 228 on the physical uplink control channel (PUCCH) (or the physical uplink control channel (PUCCH) and the physical uplink shared channel (PUSCH) simultaneously) for the subframe using Format 1/1a/1b or Format 2/2a/2b or Format 3.

Conceptually, the switching between non-simultaneous physical uplink control channel (PUCCH) and physical uplink shared channel (PUSCH) transmission and simultaneous physical uplink control channel (PUCCH) and physical uplink shared channel (PUSCH) transmission is determined based on whether the PDCCH is in the common search space and whether DCI Format 0 or another DCI format is detected.

If simultaneous physical uplink control channel (PUCCH) and physical uplink shared channel (PUSCH) is not configured, the user equipment (UE) 104 may determine 518 whether the user equipment (UE) 104 is transmitting on the physical uplink shared channel (PUSCH) for the subframe. If the user equipment (UE) 104 is transmitting on the physical uplink shared channel (PUSCH) for the subframe, the user equipment (UE) 104 may transmit 514 the uplink control information (UCI) 228 on the physical uplink shared channel (PUSCH) for the subframe. If the user equipment (UE) 104 is not transmitting on the physical uplink shared channel (PUSCH) for the subframe, the user equipment (UE) 104 may transmit 516 the uplink control information (UCI) 228 on the physical uplink control channel (PUCCH) for the subframe using Format 1/1a/1b or Format 2/2a/2b or Format 3.

FIG. 6 is a block diagram illustrating multiple subframes 661a-c of communications between a user equipment (UE) 104 and an eNode B 102. Each subframe 661 may have an uplink 660b and a downlink 660a. As discussed above, downlink 660a refers to transmissions sent from the eNode B 102 to a user equipment (UE) 104 and uplink 660b refers to transmissions sent from a user equipment (UE) 104 to an eNode B 102. In Frequency Division Duplexing (FDD), a downlink 660a transmission and an uplink 660b transmission may occur during the same subframe 661.

A downlink 660a subframe 661 may include a PDCCH region 662a-c and a PDSCH region 663a-c. The PDCCH region 662 and the PDSCH region 663 may be separated in time during a subframe 661. The PDCCH region 662 of a subframe 661 may include a common search space 668a-c and a UE specific search space 667a-c. The common search space 668 and the UE specific search space 667 may refer to a set of resource elements (REs) of the PDCCH region 662. The smallest resource unit is denoted a resource element (RE), which consists of a subcarrier and an SC-FDMA/OFDM symbol.

An uplink 660b subframe 661 may include a first PUCCH region 664a-c, a PUSCH region 665a-c and a second PUCCH region 666a-c. The first PUCCH region 664, PUSCH region 665 and second PUCCH region 666 may be separated in frequency during a subframe 661. It may be assumed that simultaneous PUCCH and PUSCH is configured for the user equipment (UE) 104. It may also be assumed that the uplink control information (UCI) 228 of FIG. 6 is periodic CQI/PMI/RI. The periodic CQI/PMI/RI and PUCCH resource for the periodic CQI/PMI/RI may be semi-statically scheduled by RRC signaling.

A user equipment (UE) 104 may know prior to a subframe 661 whether a PUSCH assignment for the subframe 661 exists. For example, in subframe n+k 661b, the user equipment (UE) 104 does not have a PUSCH assignment. Thus, the UCI 670 for subframe n+k 661b may be transmitted in the PUCCH region 664b using Format 1/1a/1b or Format 2/2a/2b or Format 3. FIG. 6 shows no simultaneous physical uplink control channel (PUCCH) and physical uplink shared channel (PUSCH) transmissions.

In the downlink 660a of subframe n+k 661b, a PDCCH with DCI Format 0 669 may be detected in the common search space 668b. Therefore, in the next subframe 661 (i.e., subframe n+k+k 661c), the user equipment (UE) 104 may transmit the UCI 672 on the PUSCH 665c (and not on the PUCCH 664c) (if any UCI 672 is scheduled in this subframe).

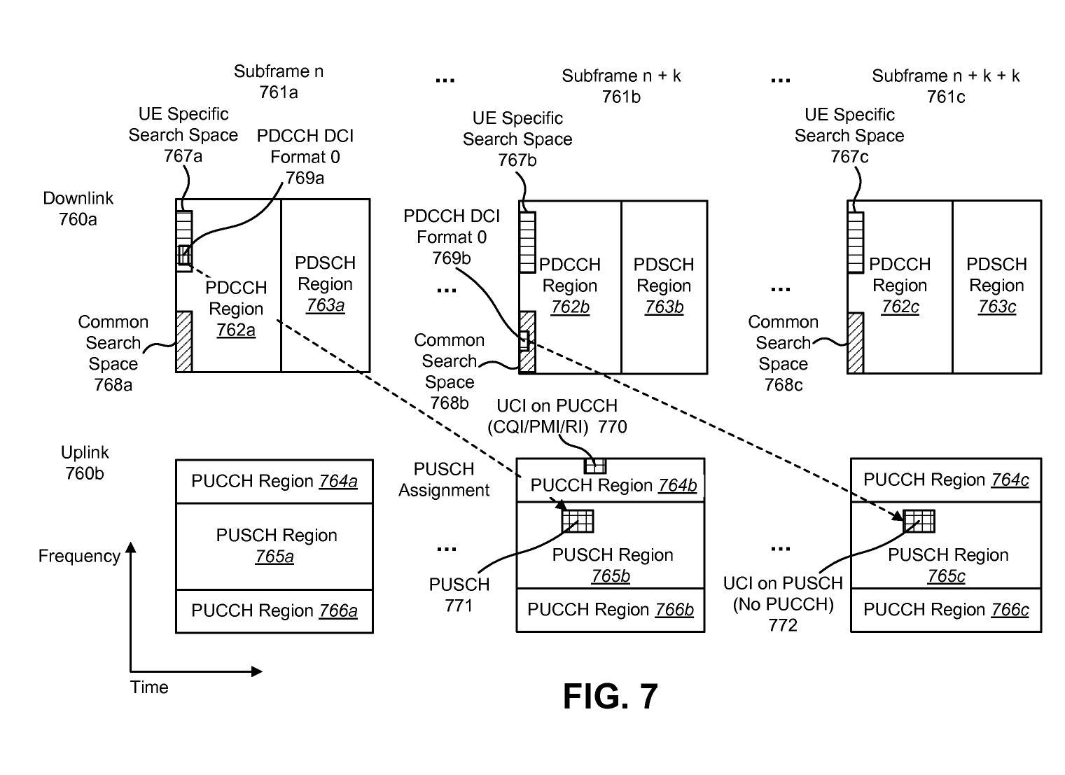

FIG. 7 is another block diagram illustrating multiple subframes 761a-c of communications between a user equipment (UE) 104 and an eNode B 102. Each subframe 761 may have an uplink 760b and a downlink 760a. In the example shown in FIG. 7, the response to a PDCCH with DCI Format 0 769a detected in the UE specific search space 767 in one subframe 761 and a PDCCH with DCI Format 0 769b detected in the common search space 768 in another subframe 761 is shown.

As discussed above, a downlink 760a subframe 761a may include a PDCCH region 762a-c and a PDSCH region 763a-c. The PDCCH region 762 and the PDSCH region 763 may be separated in time during a subframe 761. The PDCCH region 762 in a subframe 761 may include a common search space 768a-c and a UE specific search space 767a-c. The common search space 768 and the UE specific search space 767 may refer to a set of resource elements (REs) of the PDCCH region 762.

An uplink 760b subframe 761 may include a first PUCCH region 764a-c, a PUSCH region 765a-c and a second PUCCH region 766a-c. The first PUCCH region 764, PUSCH region 765 and second PUCCH region 766 may be separated in frequency during a subframe 761. It may be assumed that simultaneous PUCCH and PUSCH is configured for the user equipment (UE) 104. It may also be assumed that the uplink control information (UCI) 228 of FIG. 7 is periodic CQI/PMI/RI.

A user equipment (UE) 104 may know prior to a subframe 761 whether a PUSCH assignment for the subframe 761 exists. In subframe n+k 761b, the user equipment (UE) 104 does have a PUSCH assignment. Thus, the UCI 770 for subframe n+k 761b is dependent on whether a PDCCH with DCI Format 0 769a was detected in the common search space 768a for the previous downlink subframe 761 (i.e., subframe n 761a). In subframe n 761a, a PDCCH with DCI Format 0 769a was detected in the UE specific search space 767a (and not in the common search space 768a). Therefore, the UCI 770 for subframe n+k 761b may be transmitted in the PUCCH region 764b (or the PUCCH region 764b and the PUSCH region 765b simultaneously) using Format 1/1a/1b or Format 2/2a/2b or Format 3. The user equipment (UE) 104 may also transmit a PUSCH 771 during the subframe n+k 761b. This PUSCH 771 may or may not carry the UCI 228, depending on whether the eNode B 102 makes a request for it or if the user equipment (UE) 104, as a result of its internal measurements and processes, has UCI 228 to transmit to the eNode B 102.

In subframe n+k+k 761c, the user equipment (UE) 104 has a PUSCH assignment. Thus, the UCI 772 for subframe n+k+k 761c is dependent on whether a PDCCH with DCI Format 0 769b was detected in the common search space 768b for the previous downlink 760a subframe 761 (i.e., subframe n+k 761b). In subframe n+k 761b, a PDCCH with DCI Format 0 769b was detected in the common search space 768b. Therefore, the UCI 772 for subframe n+k+k 761c may be transmitted in the PUSCH region 765c (and not in the PUCCH region 764). Thus, the UCI 772 may be transmitted as multiplexed with/without data in the PUSCH.

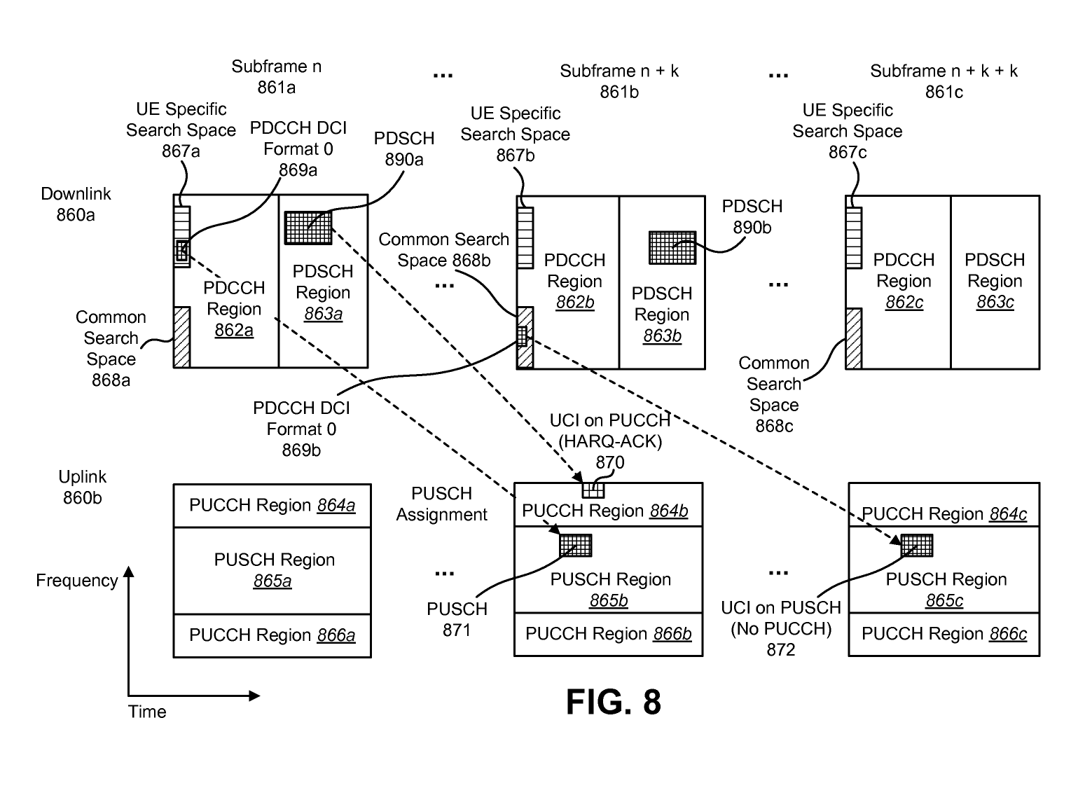

FIG. 8 is yet another block diagram illustrating multiple subframes 861a-c for communications between a user equipment (UE) 104 and an eNode B 102. Each subframe 861 may have an uplink 860b and a downlink 860a. In the example shown in FIG. 8, the response to a PDCCH with DCI Format 0 869a detected in the UE specific search space 867a in one subframe 861 and a PDCCH with DCI Format 0 869b detected in the common search space 868b in another subframe 861 is shown when the user equipment (UE) 104 is also transmitting an HARQ-ACK 240 for the PDSCH region 863 (i.e., the user equipment (UE) 104 transmits an HARQ-ACK 240 in the PUCCH region 864 in response to detecting a PDSCH 890a-b in the previous subframe 861).

As discussed above, a downlink 860a subframe 861 may include a PDCCH region 862a-c and a PDSCH region 863a-c. The PDCCH region 862 and the PDSCH region 863 may be separated in time during a subframe 861. The PDCCH region 862 in a subframe 861 may include a common search space 868a-c and a UE specific search space 867a-c. The common search space 868 and the UE specific search space 867 may refer to a set of resource elements (REs) of the PDCCH region 862.

An uplink 860b subframe 861 may include a first PUCCH region 864a-c, a PUSCH region 865a-c and a second PUCCH region 866a-c. The first PUCCH region 864, PUSCH region 865 and second PUCCH region 866 may be separated in frequency during a subframe 861. It may be assumed that simultaneous PUCCH and PUSCH is configured for the user equipment (UE) 104.

If a user equipment (UE) 104 detects a PDSCH 890 in the downlink 860a PDSCH region 863 of a subframe 861, the UCI 228 in the next subframe 861 may be an HARQ-ACK 240. A user equipment (UE) 104 may know prior to a subframe 861 whether a PUSCH assignment for the subframe 861 exists. In subframe n+k 861b, the user equipment (UE) 104 does have a PUSCH assignment. Thus, the UCI 870 for subframe n+k 861b is dependent on whether a PDCCH with DCI Format 0 869a was detected in the common search space 868a for the previous downlink subframe 861 (i.e., subframe n 861a). In subframe n 861a, a PDCCH with DCI Format 0 869a was detected in the UE specific search space 867a (and not in the common search space 868a). Therefore, the UCI 870 for subframe n+k 861b may be transmitted in the PUCCH region 864b (or the PUCCH region 864b and the PUSCH region 865b simultaneously) using Format 1/1a/1b or Format 2/2a/2b or Format 3. The user equipment (UE) 104 may also transmit a PUSCH 871 during the subframe n+k 861b. This PUSCH 871 may or may not carry the UCI 228 according to the need.

In subframe n+k+k 861c, the user equipment (UE) 104 has a PUSCH assignment. Thus, the UCI 872 for subframe n+k+k 861c is dependent on whether a PDCCH with DCI Format 0 869b was detected in the common search space 868b for the previous downlink subframe 861 (i.e., subframe n+k 861b). In subframe n+k 861b, a PDCCH with DCI Format 0 869b was detected in the common search space 868b. Therefore, the UCI 872 for subframe n+k+k 861c may be transmitted in the PUSCH region 865c (and not in the PUCCH region 864c). Thus, the UCI 872 may be transmitted as multiplexed with/without data in the PUSCH.

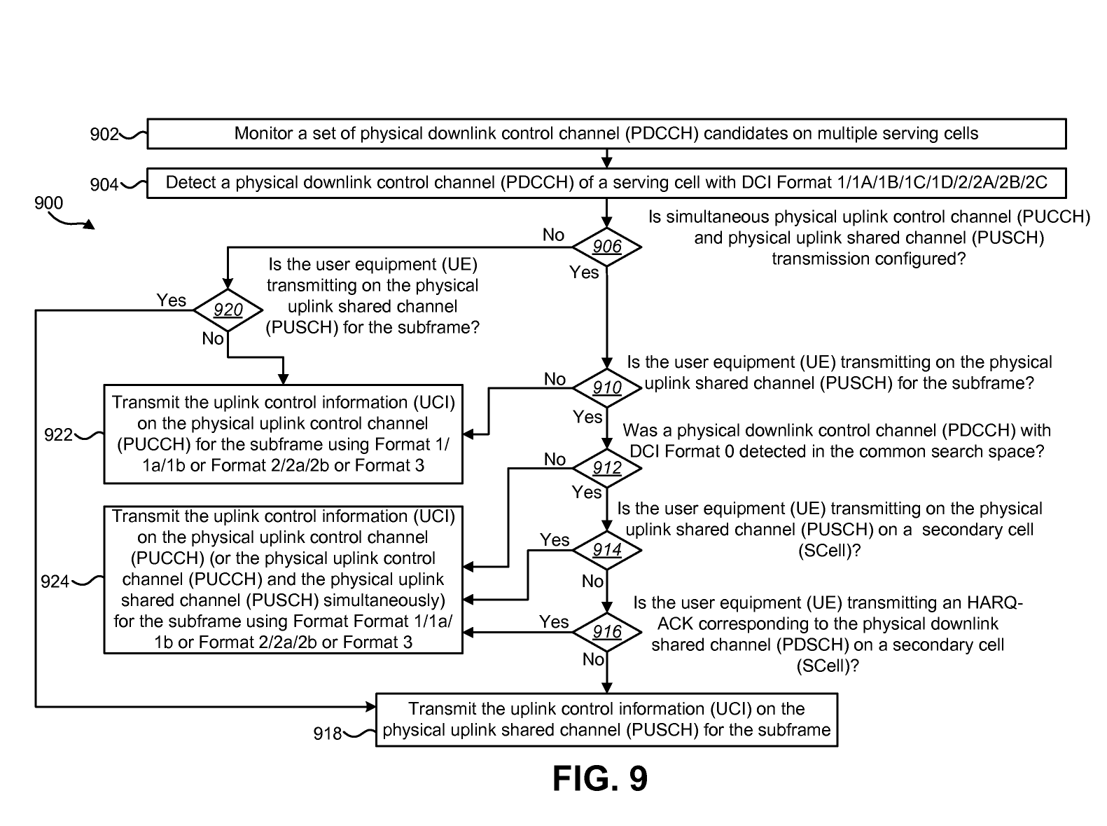

FIG. 9 is a flow diagram of a method 900 for transmitting uplink control information (UCI) 228 when there are multiple serving cells 185. The method 900 may be performed by a user equipment (UE) 104. The user equipment 104 may monitor 902 a set of physical downlink control channel (PDCCH) candidates on multiple serving cells 185. The user equipment (UE) 104 may detect 904 a physical downlink control channel (PDCCH) of a serving cell 185 with DCI Format 1/1A/1B/1C/1D/2/2A/2B/2C. The user equipment (UE) 104 may then determine 906 whether simultaneous physical uplink control channel (PUCCH) and physical uplink shared channel (PUSCH) transmission is configured for the user equipment (UE) 104.

The use of simultaneous physical uplink shared channel (PUSCH) and physical uplink control channel (PUCCH) transmissions may be configured by the radio resource control (RRC) configuration based on user equipment (UE) 104 specific RRC signaling. For example, if a parameter SimultaneousPUCCHandPUSCH is set to TRUE, simultaneous physical uplink shared channel (PUSCH) and physical uplink control channel (PUCCH) transmissions may be configured (i.e., be allowed), otherwise simultaneous physical uplink shared channel (PUSCH) and physical uplink control channel (PUCCH) transmissions may not be configured (i.e., not be allowed).

If simultaneous physical uplink control channel (PUCCH) and physical uplink shared channel (PUSCH) transmission is configured for the user equipment (UE) 104, the user equipment (UE) 104 may determine 910 whether the user equipment (UE) 104 is transmitting on the physical uplink shared channel (PUSCH) for the subframe. If the user equipment (UE) 104 is not transmitting on the physical uplink shared channel (PUSCH) for the subframe, the user equipment (UE) 104 may transmit 922 the uplink control information (UCI) 228 on the physical uplink control channel (PUCCH) for the subframe using Format 1/1a/1b or Format 2/2a/2b or Format 3.

If the user equipment (UE) 104 is transmitting on the physical uplink shared channel (PUSCH) for the subframe, the user equipment (UE) 104 may determine 912 whether a physical downlink control channel (PDCCH) with DCI Format 0 769 was detected in the common search space 768 of the previous subframe. If a physical downlink control channel (PDCCH) with DCI Format 0 769 was not detected in the common search space 768 (and thus was either detected in the UE specific search space 767 or another DCI format was detected), the user equipment (UE) 104 may transmit 924 the uplink control information (UCI) 228 on the physical uplink control channel (PUCCH) (or the physical uplink control channel (PUCCH) and the physical uplink shared channel (PUSCH) simultaneously) for the subframe using Format 1/1a/1b or Format 2/2a/2b or Format 3.

If a physical downlink control channel (PDCCH) with DCI Format 0 769 was detected in the common search space 768, the user equipment (UE) 104 may determine 914 whether the user equipment (UE) is transmitting on the physical uplink shared channel (PUSCH) on a secondary cell (SCell) 185b. If the user equipment (UE) 104 is transmitting on the physical uplink shared channel (PUSCH) on a secondary cell (SCell) 185b, the user equipment (UE) 104 may transmit 924 the uplink control information (UCI) 228 on the physical uplink control channel (PUCCH) (or the physical uplink control channel (PUCCH) and the physical uplink shared channel (PUSCH) simultaneously) for the subframe using Format 1/1a/1b or Format 2/2a/2b or Format 3. If the user equipment (UE) 104 is not transmitting on the physical uplink shared channel (PUSCH) on a secondary cell (SCell) 185b, the user equipment (UE) 104 may determine 916 whether the user equipment (UE) 104 is transmitting an HARQ-ACK 240 corresponding to the PDSCH 890 received on a secondary cell (SCell) 185b.

If the user equipment (UE) 104 is transmitting an HARQ-ACK 240 corresponding to the PDSCH 890 received on a secondary cell (SCell) 185b, the user equipment (UE) 104 may transmit 924 the uplink control information (UCI) 228 on the physical uplink control channel (PUCCH) (or the physical uplink control channel (PUCCH) and the physical uplink shared channel (PUSCH) simultaneously) for the subframe using Format 1/1a/1b or Format 2/2a/2b or Format 3. If the user equipment (UE) 104 is not transmitting an HARQ-ACK 240 corresponding to the PDSCH 890 received on a secondary cell (SCell) 185b, the user equipment (UE) 104 may transmit 918 the uplink control information (UCI) 228 on the physical uplink shared channel (PUSCH) for the subframe.

If the user equipment (UE) 104 is not transmitting on the physical uplink shared channel (PUSCH) on a secondary cell (SCell) 185b and the user equipment (UE) 104 is not transmitting an HARQ-ACK 240 corresponding to the PDSCH 890 received on a secondary cell (SCell) 185b, then the user equipment (UE) 104 has detected only one PDCCH with DCI Format 0 769 to allocate the physical uplink shared channel (PUSCH) on a primary cell (PCell) 185a and the user equipment (UE) 104 has decoded the PDSCH 890 only on the primary cell (PCell) 185a in a subframe n 861a corresponding to an HARQ-ACK 240 transmission in the subframe n+k 861b. Conceptually, the switching between non-simultaneous physical uplink control channel (PUCCH) and physical uplink shared channel (PUSCH) and simultaneous physical uplink control channel (PUCCH) and physical uplink shared channel (PUSCH) is determined based on whether the PDCCH 769 is in the common search space 768, which DCI Format 0 or other DCI format is detected, and/or whether uplink 760b and downlink 760a procedures are done only on the primary cell (PCell) 185a.

If simultaneous physical uplink control channel (PUCCH) and physical uplink shared channel (PUSCH) is not configured, the user equipment (UE) 104 may determine 920 whether the user equipment (UE) 104 is transmitting on the physical uplink shared channel (PUSCH) for the subframe. If the user equipment (UE) 104 is transmitting on the physical uplink shared channel (PUSCH) for the subframe, the user equipment (UE) 104 may transmit 918 the uplink control information (UCI) 228 on the physical uplink shared channel (PUSCH) for the subframe. If the user equipment (UE) 104 is not transmitting on the physical uplink shared channel (PUSCH) for the subframe, the user equipment (UE) 104 may transmit 922 the uplink control information (UCI) 228 on the physical uplink control channel (PUCCH) for the subframe using Format 1/1a/1b or Format 2/2a/2b or Format 3.

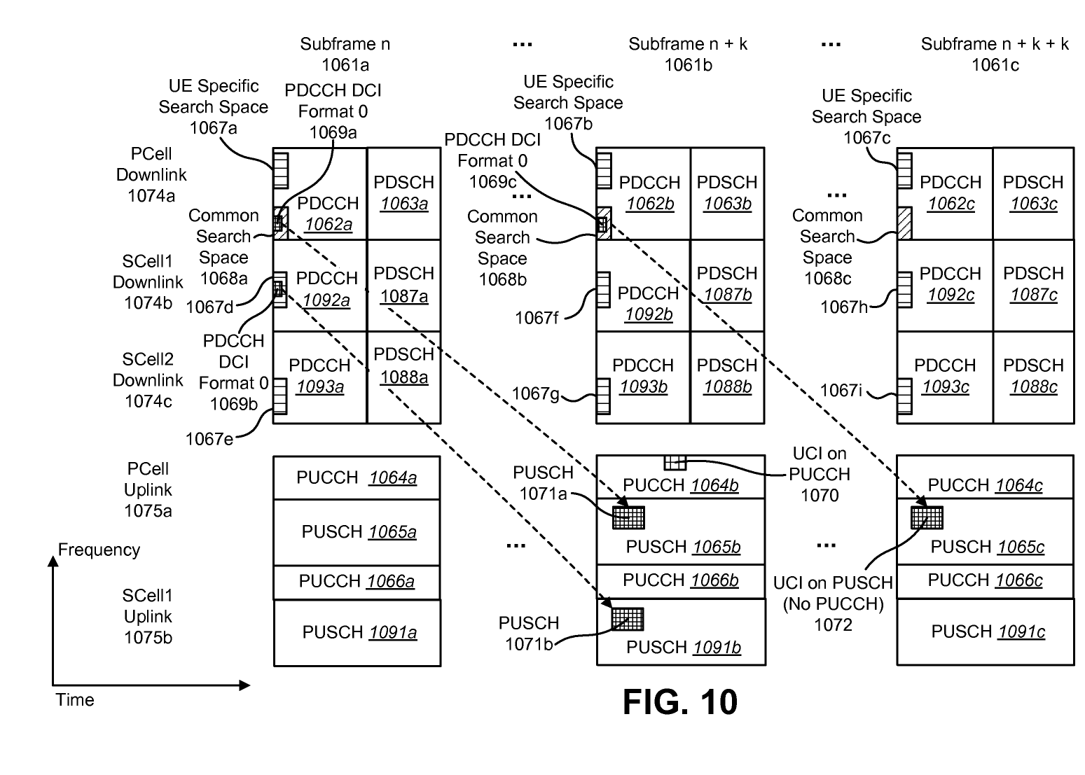

FIG. 10 is a block diagram illustrating multiple subframes 1061a-c of communications between a user equipment (UE) 104 and an eNode B 102 when there are multiple serving cells 185. The serving cells 185 may include a primary cell (PCell) 185a, a first secondary cell (SCell1) 185b and a second secondary cell (SCell2) 185b. Each subframe 1061 may include a primary cell (PCell) downlink 1074a, an SCell1 downlink 1074b and an SCell2 downlink 1074c. Each subframe 1061 may also include a PCell uplink 1075a and an SCell1 uplink 1075b.

As discussed above, a downlink 1074 subframe 1061 may include a PDCCH region 1062a-c, 1692a-c, 1093a-c and a PDSCH region 1063a-c, 1087a-c, 1088a-c. The PDCCH region 1062, 1092, 1093 and the PDSCH region 1063, 1087, 1088 may be separated in time during a subframe 1061. The PDCCH region 1062 of a subframe 1061 of the primary cell (PCell) downlink 1074a may include a common search space 1068a-c and a UE specific search space 1067a-c. The PDCCH region 1092, 1093 of a subframe 1061 of a secondary cell 185b (SCell1 or SCell2) downlink 1074b, 1074c may include a UE specific search space 1067d-i. The common search space 1068 and the UE specific search space 1067 may refer to a set of resource elements (REs) of the PDCCH region 1062, 1092, 1093.

The primary cell (PCell) uplink 1075a subframe 1061 may include a first PUCCH region 1064a-c, a first PUSCH region 1065a-c and a second PUCCH region 1066a-c. The secondary cell (SCell1) uplink 1075b subframe 1061 may include a second PUSCH region 1091a-c. The first PUCCH region 1064, first PUSCH region 1065, second PUCCH region 1066 and second PUSCH region 1091 may be separated in frequency during a subframe 1061. It may be assumed that simultaneous PUCCH and PUSCH is configured for the user equipment (UE) 104. It may also be assumed that the uplink control information (UCI) 228 of FIG. 10 is periodic CQI/PMI/RI.

In subframe n 1061a, the user equipment (UE) 104 detects a PDCCH with DCI Format 0 1069a in the common search space 1068a of the primary cell (PCell) downlink 1074a and a PDCCH with DCI Format 0 1069b in the UE specific search space 1067d of the SCell1 downlink 1074b. Therefore, in subframe n+k 1061b the user equipment (UE) 104 may transmit the UCI 1070 on the first PUCCH region 1064b (or the first PUCCH region 1064b and the first PUSCH region 1065b simultaneously). In subframe n+k 1061b, the user equipment (UE) 104 may also transmit a PUSCH 1071 on the first PUSCH region 1065b on the primary cell (PCell) uplink 1075a and a PUSCH 1071b on the second PUSCH region 1091b on SCell1 uplink 1075b.

In subframe n+k 1061b, the user equipment (UE) 104 only detects a PDCCH with DCI Format 0 1069c in the common search space 1068b of the primary cell (PCell) downlink 1074a. Therefore, the user equipment (UE) 104 transmits the UCI 1072 on the first PUSCH region 1065c of the primary cell (PCell) uplink 1075a and not on the first PUCCH region 1064c. Thus, the UCI 1072 may be transmitted as multiplexed with/without data in the PUSCH.

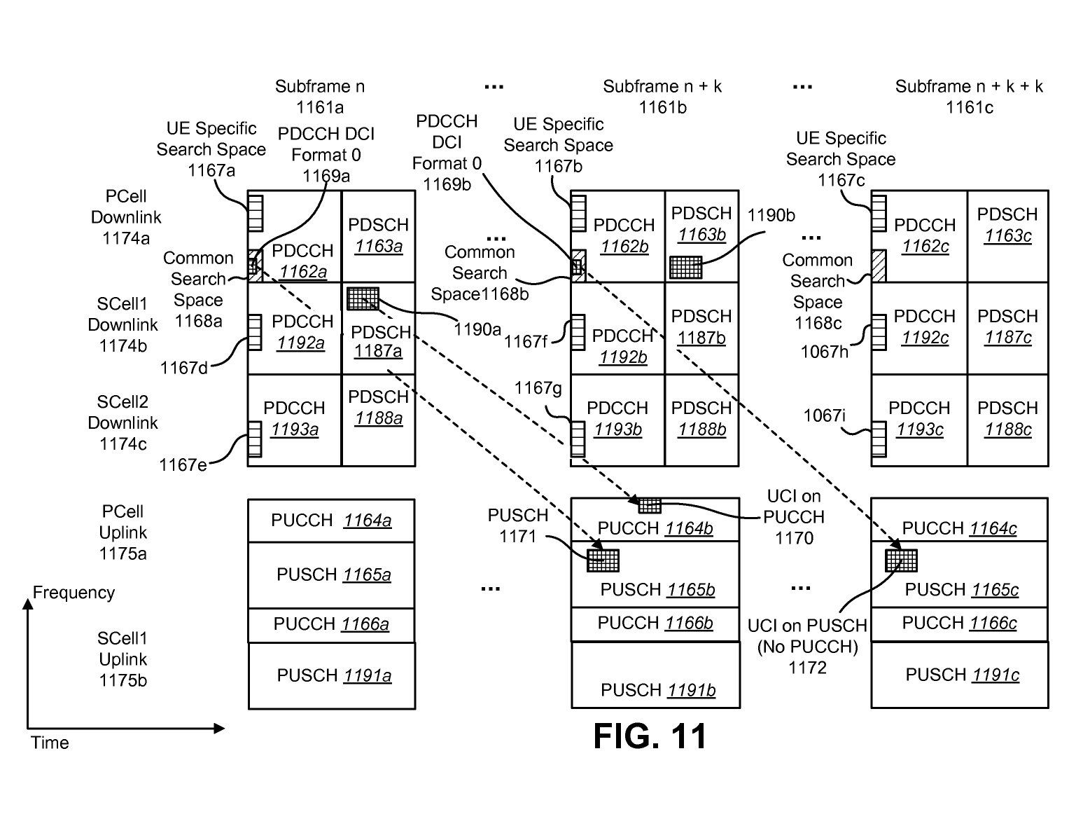

FIG. 11 is another block diagram illustrating multiple subframes 1161a-c of communications between a user equipment (UE) 104 and an eNode B 102 when there are multiple serving cells 185. Each subframe 1161 may include a primary cell (PCell) downlink 1174a, an SCell1 downlink 1174b and an SCell2 downlink 1174c. Each subframe 1161 may also include a PCell uplink 1175a and an SCell1 uplink 1175b.

As discussed above, a downlink 1174 subframe 1161 may include a PDCCH region 1162a-c, 1192a-c, 1193a-c and a PDSCH region 1163a-c, 1187a-c, 1188a-c. The PDCCH region 1162, 1192, 1193 and the PDSCH region 1163, 1187, 1188 may be separated in time during a subframe 1161. The PDCCH region 1162 of a subframe 1161 of the primary cell (PCell) downlink 1174a may include a common search space 1168a-c and a UE specific search space 1167a-c. The PDCCH region 1192, 1193 of a subframe 1161 of a secondary cell (SCell1 or SCell2) downlink 1174b-c may include a UE specific search space 1167d-i. The common search space 1168 and the UE specific search space 1167 may refer to a set of resource elements (REs) of the PDCCH region 1162, 1192, 1193.

The primary cell (PCell) uplink 1175a subframe 1161 may include a first PUCCH region 1164a-c, a first PUSCH region 1165a-c and a second PUCCH region 1166a-c. The SCell1 uplink 1175b subframe 1161 may include a second PUSCH region 1191a-c. The first PUCCH region 1164, first PUSCH region 1165, second PUCCH region 1166 and second PUSCH region 1191 may be separated in frequency during a subframe 1161. It may be assumed that simultaneous PUCCH and PUSCH is configured for the user equipment (UE) 104.

In subframe n 1161a, the user equipment (UE) 104 detects a PDCCH with DCI Format 0 1169a in the common search space 1168a of the primary cell (PCell) downlink 1174a. The user equipment (UE) 104 also decodes a PDSCH 1190a in the PDSCH region 1187a of SCell1 downlink 1174b. Therefore, in subframe n+k 1161b the user equipment (UE) 104 may transmit the UCI 1170 on the first PUCCH region 1164b (or the first PUCCH region 1164b and the first PUSCH region 1165b simultaneously). The UCI 1170 may be an HARQ-ACK 240 for the PDSCH on the secondary cell (SCell) 185b. In subframe n+k 1161b, the user equipment (UE) 104 may also transmit a PUSCH 1171 on the first PUSCH region 1165b. This PUSCH 1171 may carry the UCI 228 according to the need.

In subframe n+k 1161b, the user equipment (UE) 104 detects only one PDCCH with DCI Format 0 1169b (in the common search space 1168b of the primary cell (PCell) downlink 1174a) to allocate the first PUSCH region 1165 on a primary cell (PCell) 185a. The user equipment (UE) 104 has also decoded a PDSCH 1190b only on the primary cell (PCell) downlink 1174a in the subframe n+k 1161b. Therefore, the user equipment (UE) 104 transmits the UCI 1172 on the first PUSCH region 1165c of the primary cell (PCell) uplink 1175a in the subframe n+k+k 1161c and not on the first PUCCH region 1164c. The UCI 1172 may be an HARQ-ACK 240 for the PDSCH on the primary cell (PCell) 185a. Thus, the UCI 1172 may be transmitted as multiplexed with/without data in the PUSCH.

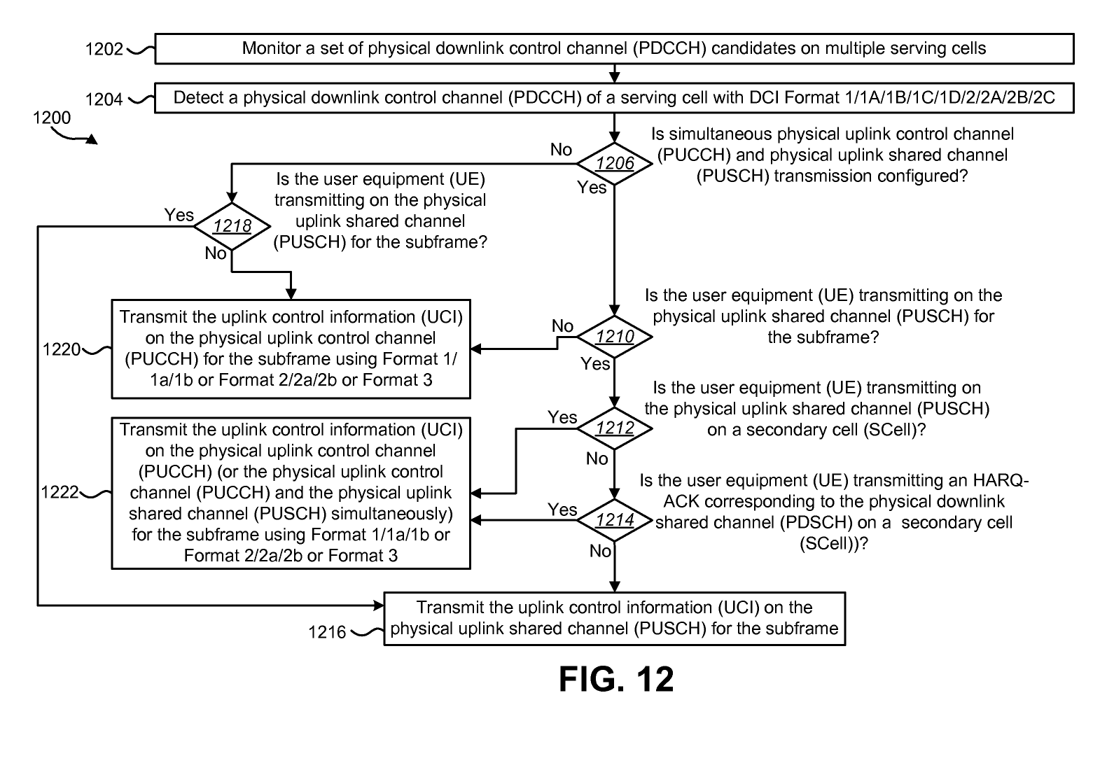

FIG. 12 is a flow diagram of a simplified method 1200 for transmitting uplink control information (UCI) 228 when there are multiple serving cells 185 that does not take search space into account. The method 1200 may be performed by a user equipment (UE) 104. The user equipment (UE) 104 may monitor 1202 a set of physical downlink control channel (PDCCH) candidates on multiple serving cells 185. The user equipment (UE) 104 may detect 1204 a physical downlink control channel (PDCCH) of a serving cell 185 with DCI Format 1/1A/1B/1C/1D/2/2A/2B/2C. The user equipment (UE) 104 may then determine 1206 whether simultaneous physical uplink control channel (PUCCH) and physical uplink shared channel (PUSCH) transmission is configured for the user equipment (UE) 104.

The use of simultaneous physical uplink shared channel (PUSCH) and physical uplink control channel (PUCCH) transmissions may be configured by the radio resource control (RRC) configuration based on user equipment (UE) 104 specific RRC signaling. For example, if a parameter SimultaneousPUCCHandPUSCH is set to TRUE, simultaneous physical uplink shared channel (PUSCH) and physical uplink control channel (PUCCH) transmissions may be configured (be allowed), otherwise simultaneous physical uplink shared channel (PUSCH) and physical uplink control channel (PUCCH) transmissions may not be configured (not be allowed).

If simultaneous physical uplink control channel (PUCCH) and physical uplink shared channel (PUSCH) transmission is configured for the user equipment (UE) 104, the user equipment (UE) 104 may determine 1210 whether the user equipment (UE) 104 is transmitting on the physical uplink shared channel (PUSCH) for the subframe. If the user equipment (UE) 104 is not transmitting on the physical uplink shared channel (PUSCH) for the subframe, the user equipment (UE) 104 may transmit 1220 the uplink control information (UCI) 228 on the physical uplink control channel (PUCCH) for the subframe using Format 1/1a/1b or Format 2/2a/2b or Format 3.

If the user equipment (UE) 104 is transmitting on the physical uplink shared channel (PUSCH) for the subframe, the user equipment (UE) 104 may determine 1212 whether the user equipment (UE) 104 is transmitting on the physical uplink shared channel (PUSCH) on a secondary cell (SCell) 185b. If the user equipment (UE) 104 is transmitting on the physical uplink shared channel (PUSCH) on a secondary cell (SCell) 185b, the user equipment (UE) 104 may transmit 1222 the uplink control information (UCI) 228 on the physical uplink control channel (PUCCH) (or the physical uplink control channel (PUCCH) and the physical uplink shared channel (PUSCH) simultaneously) for the subframe using Format 1/1a/1b or Format 2/2a/2b or Format 3. If the user equipment (UE) 104 is not transmitting on the physical uplink shared channel (PUSCH) on a secondary cell (SCell) 185b, the user equipment (UE) 104 may determine 1214 whether the user equipment (UE) 104 is transmitting an HARQ-ACK 240 corresponding to the physical downlink shared channel (PDSCH) on a secondary cell (SCell) 185b.

If the user equipment (UE) 104 is transmitting an HARQ-ACK 240 corresponding to the physical downlink shared channel (PDSCH) on a secondary cell (SCell) 185b, the user equipment (UE) 104 may transmit 1222 the uplink control information (UCI) 228 on the physical uplink control channel (PUCCH) (or the physical uplink control channel (PUCCH) and the physical uplink shared channel (PUSCH) simultaneously) for the subframe using Format 1/1a/1b or Format 2/2a/2b or Format 3. If the user equipment (UE) 104 is not transmitting an HARQ-ACK 240 corresponding to the physical uplink shared channel (PDSCH) on a secondary cell (SCell) 185b, the user equipment (UE) 104 may transmit 1216 the uplink control information (UCI) 228 on the physical uplink shared channel (PUSCH) for the subframe.

If the user equipment (UE) 104 is not transmitting on the physical uplink shared channel (PUSCH) on a secondary cell (SCell) 185b and the user equipment (UE) 104 is not transmitting an HARQ-ACK 240 corresponding to the physical downlink shared channel (PDSCH) on a secondary cell (SCell) 185b, then the user equipment (UE) 104 has detected only one physical downlink control channel (PDCCH) to allocate the physical uplink shared channel (PUSCH) on a PCell 185a and the user equipment (UE) 104 has decoded the physical downlink shared channel (PDSCH) only on the PCell 185a in a subframe n 1161a corresponding to an HARQ-ACK 240 transmission in the subframe n+k 1161b. Conceptually, the switching between non-simultaneous physical uplink control channel (PUCCH) and physical uplink shared channel (PUSCH) and simultaneous physical uplink control channel (PUCCH) and physical uplink shared channel (PUSCH) is determined based on whether uplink and downlink procedures are done only on the primary cell (PCell) 185a.

If simultaneous physical uplink control channel (PUCCH) and physical uplink shared channel (PUSCH) is not configured, the user equipment (UE) 104 may determine 1218 whether the user equipment (UE) 104 is transmitting on the physical uplink shared channel (PUSCH) for the subframe. If the user equipment (UE) 104 is transmitting on the physical uplink shared channel (PUSCH) for the subframe, the user equipment (UE) 104 may transmit 1216 the uplink control information (UCI) 228 on the physical uplink shared channel (PUSCH) for the subframe. If the user equipment (UE) 104 is not transmitting on the physical uplink shared channel (PUSCH) for the subframe, the user equipment (UE) 104 may transmit 1220 the uplink control information (UCI) 228 on the physical uplink control channel (PUCCH) for the subframe using Format 1/1a/1b or Format 2/2a/2b or Format 3.

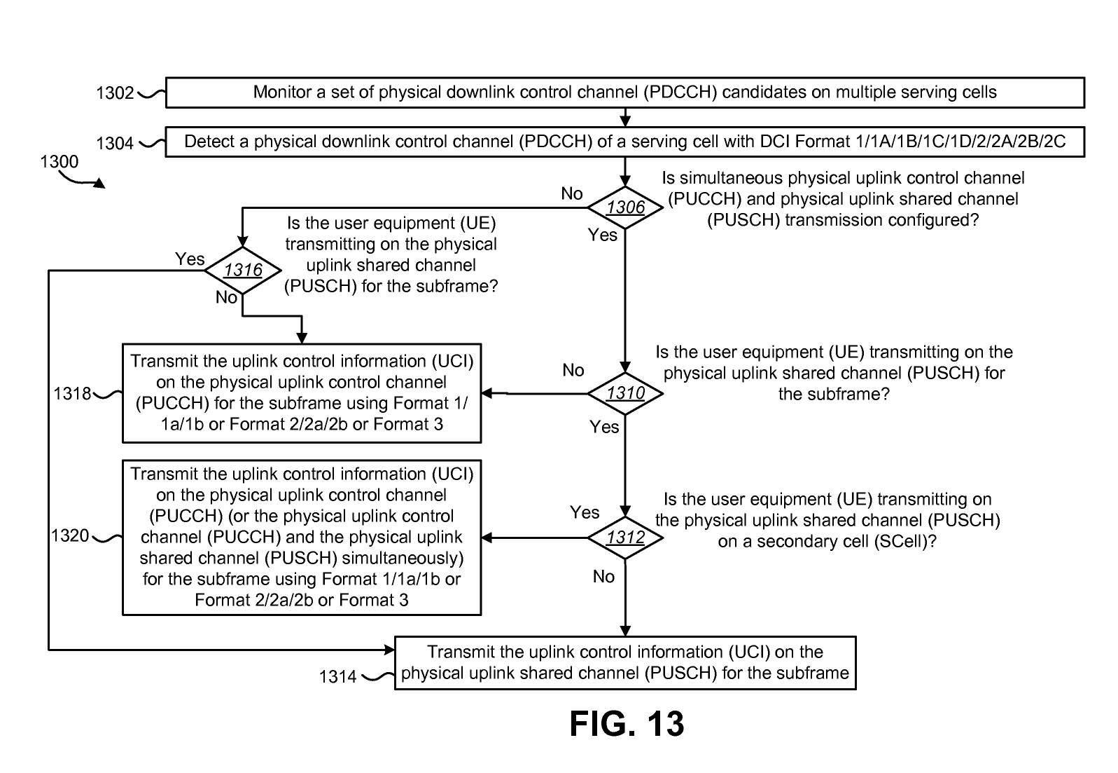

FIG. 13 is a flow diagram of a simplified method 1300 for transmitting uplink control information (UCI) 228 when there are multiple serving cells 185 that does not take search space or an HARQ-ACK 240 corresponding to the physical downlink shared channel (PDSCH) of a secondary cell (SCell) 185b into account. The method 1300 may be performed by a user equipment (UE) 104. The user equipment (UE) 104 may monitor 1302 a set of physical downlink control channel (PDCCH) candidates on multiple serving cells 185. The user equipment (UE) 104 may detect 1304 a physical downlink control channel (PDCCH) of a serving cell 185 with Format 1/1A/1B/1C/1D/2/2A/2B/2C. The user equipment (UE) 104 may then determine 1306 whether simultaneous physical uplink control channel (PUCCH) and physical uplink shared channel (PUSCH) transmission is configured for the user equipment (UE) 104.

The use of simultaneous physical uplink shared channel (PUSCH) and physical uplink control channel (PUCCH) transmissions may be configured by the radio resource control (RRC) configuration based on user equipment (UE) 104 specific RRC signaling. For example, if a parameter SimultaneousPUCCHandPUSCH is set to TRUE, simultaneous physical uplink shared channel (PUSCH) and physical uplink control channel (PUCCH) transmissions may be configured (be allowed), otherwise simultaneous physical uplink shared channel (PUSCH) and physical uplink control channel (PUCCH) transmissions may not be configured (not be allowed).

If simultaneous physical uplink control channel (PUCCH) and physical uplink shared channel (PUSCH) transmission is configured for the user equipment (UE) 104, the user equipment (UE) 104 may determine 1310 whether the user equipment (UE) 104 is transmitting on the physical uplink shared channel (PUSCH) for the subframe. If the user equipment (UE) 104 is not transmitting on the physical uplink shared channel (PUSCH) for the subframe, the user equipment (UE) 104 may transmit 1318 the uplink control information (UCI) 228 on the physical uplink control channel (PUCCH) for the subframe using Format 1/1a/1b or Format 2/2a/2b or Format 3.

If the user equipment (UE) 104 is transmitting on the physical uplink shared channel (PUSCH) for the subframe, the user equipment (UE) 104 may determine 1312 whether the user equipment (UE) 104 is transmitting on the physical uplink shared channel (PUSCH) on a secondary cell (SCell) 185b. If the user equipment (UE) 104 is transmitting on the physical uplink shared channel (PUSCH) on a secondary cell (SCell) 185b, the user equipment (UE) 104 may transmit 1320 the uplink control information (UCI) 228 on the physical uplink control channel (PUCCH) (or the physical uplink control channel (PUCCH) and the physical uplink shared channel (PUSCH) simultaneously) for the subframe using Format 1/1a/1b or Format 2/2a/2b or Format 3. If the user equipment (UE) 104 is not transmitting on the physical uplink shared channel (PUSCH) on a secondary cell (SCell) 185b, the user equipment (UE) 104 may transmit 1314 the uplink control information (UCI) 228 on the physical uplink shared channel (PUSCH) for the subframe.

If the user equipment (UE) 104 is transmitting on the physical uplink shared channel (PUSCH) in a subframe and the user equipment (UE) 104 is not transmitting on the physical uplink shared channel (PUSCH) on a secondary cell (SCell) 185b, then the user equipment (UE) 104 has detected only one physical downlink control channel (PDCCH) with DCI Format 0/4 to allocate the physical uplink shared channel (PUSCH) on the primary cell (PCell) 185a. Conceptually, the switching between non-simultaneous physical uplink control channel (PUCCH) and physical uplink shared channel (PUSCH) and simultaneous physical uplink control channel (PUCCH) and physical uplink shared channel (PUSCH) is determined based on whether physical uplink shared channel (PUSCH) transmission is done only on the primary cell (PCell) 185a.

If simultaneous physical uplink control channel (PUCCH) and physical uplink shared channel (PUSCH) is not configured, the user equipment (UE) 104 may determine 1316 whether the user equipment (UE) 104 is transmitting on the physical uplink shared channel (PUSCH) for the subframe. If the user equipment (UE) 104 is transmitting on the physical uplink shared channel (PUSCH) for the subframe, the user equipment (UE) 104 may transmit 1314 the uplink control information (UCI) 228 on the physical uplink shared channel (PUSCH) for the subframe. If the user equipment (UE) 104 is not transmitting on the physical uplink shared channel (PUSCH) for the subframe, the user equipment (UE) 104 may transmit 1318 the uplink control information (UCI) 228 on the physical uplink control channel (PUCCH) for the subframe using Format 1/1a/1b or Format 2/2a/2b or Format 3.

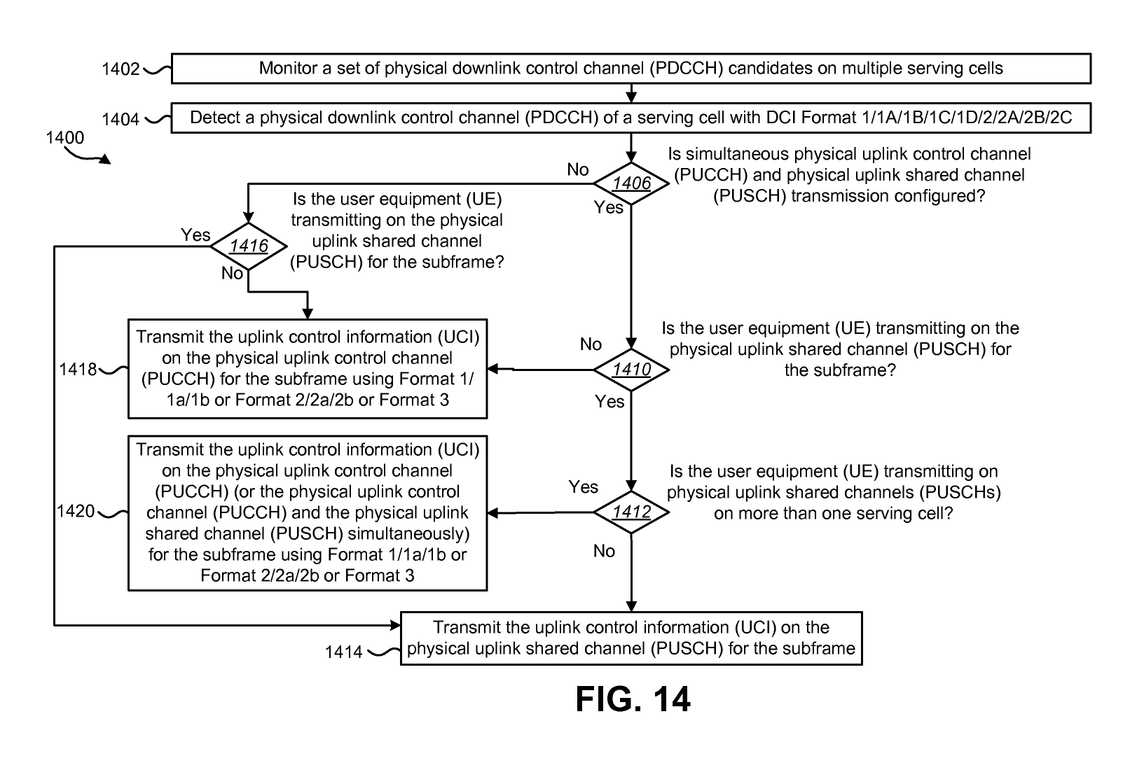

FIG. 14 is a flow diagram of another simplified method 1400 for transmitting uplink control information (UCI) 228 when there are multiple serving cells 185 that depends on whether physical uplink shared channel (PUSCH) transmission is done on only one serving cell 185. The method 1400 may be performed by a user equipment (UE) 104. The user equipment (UE) 104 may monitor 1402 a set of physical downlink control channel (PDCCH) candidates on multiple serving cells 185. The user equipment (UE) 104 may detect 1404 a physical downlink control channel (PDCCH) of a serving cell with Format 1/1A/1B/1C/1D/2/2A/2B/2C. The user equipment (UE) 104 may then determine 1406 whether simultaneous physical uplink control channel (PUCCH) and physical uplink shared channel (PUSCH) transmission is configured for the user equipment (UE) 104.

The use of simultaneous physical uplink shared channel (PUSCH) and physical uplink control channel (PUCCH) transmissions may be configured by the radio resource control (RRC) configuration based on user equipment (UE) 104 specific RRC signaling. For example, if a parameter SimultaneousPUCCHandPUSCH is set to TRUE, simultaneous physical uplink shared channel (PUSCH) and physical uplink control channel (PUCCH) transmissions may be configured (be allowed), otherwise simultaneous physical uplink shared channel (PUSCH) and physical uplink control channel (PUCCH) transmissions may not be configured (not be allowed).

If simultaneous physical uplink control channel (PUCCH) and physical uplink shared channel (PUSCH) transmission is configured for the user equipment (UE) 104, the user equipment (UE) 104 may determine 1410 whether the user equipment (UE) 104 is transmitting on the physical uplink shared channel (PUSCH) for the subframe. If the user equipment (UE) 104 is not transmitting on the physical uplink shared channel (PUSCH) for the subframe, the user equipment (UE) 104 may transmit 1418 the uplink control information (UCI) 228 on the physical uplink control channel (PUCCH) for the subframe using Format 1/1a/1b or Format 2/2a/2b or Format 3.

If the user equipment (UE) 104 is transmitting on the physical uplink shared channel (PUSCH) for the subframe, the user equipment (UE) 104 may determine 1412 whether the user equipment (UE) 104 is transmitting on the physical uplink shared channels (PUSCHs) on more than one serving cell 185. If the user equipment (UE) 104 is transmitting on the physical uplink shared channels (PUSCHs) on more than one serving cell 185, the user equipment (UE) 104 may transmit 1420 the uplink control information (UCI) 228 on the physical uplink control channel (PUCCH) (or the physical uplink control channel (PUCCH) and the physical uplink shared channel (PUSCH) simultaneously) for the subframe using Format 1/1a/1b or Format 2/2a/2b or Format 3. If the user equipment (UE) 104 is not transmitting on the physical uplink shared channels (PUSCHs) on more than one serving cell 185, the user equipment (UE) 104 may transmit 1414 the uplink control information (UCI) 228 on the physical uplink shared channel (PUSCH) for the subframe.

If the user equipment (UE) 104 is transmitting on the physical uplink shared channel (PUSCH) on only one serving cell 185 in a subframe, then the user equipment (UE) 104 has detected only one physical downlink control channel (PDCCH) PDCCH with DCI Format 0/4 to allocate the physical uplink shared channel (PUSCH) on the primary cell (PCell) 185a. Conceptually, the switching between non-simultaneous physical uplink control channel (PUCCH) and physical uplink shared channel (PUSCH) and simultaneous physical uplink control channel (PUCCH) and physical uplink shared channel (PUSCH) is determined based on whether physical uplink shared channel (PUSCH) transmission is done on only one serving cell 185.

If simultaneous physical uplink control channel (PUCCH) and physical uplink shared channel (PUSCH) is not configured, the user equipment (UE) 104 may determine 1416 whether the user equipment (UE) 104 is transmitting on the physical uplink shared channel (PUSCH) for the subframe. If the user equipment (UE) 104 is transmitting on the physical uplink shared channel (PUSCH) for the subframe, the user equipment (UE) 104 may transmit 1414 the uplink control information (UCI) 228 on the physical uplink shared channel (PUSCH) for the subframe. If the user equipment (UE) 104 is not transmitting on the physical uplink shared channel (PUSCH) for the subframe, the user equipment (UE) 104 may transmit 1418 the uplink control information (UCI) 228 on the physical uplink control channel (PUCCH) for the subframe using Format 1/1a/1b or Format 2/2a/2b or Format 3.

These procedures are described from the user equipment (UE) 104 perspective, but an eNode B 102 can control the user equipment (UE) 104 behaviors according to the defined procedures of the user equipment (UE) 104. Namely, an eNode B 102 can obtain a UCI 228 by setting which channels carry the UCI 228 based on the configurations and/or the physical downlink control channel and/or physical downlink shared channel transmitted by the eNode B 102.

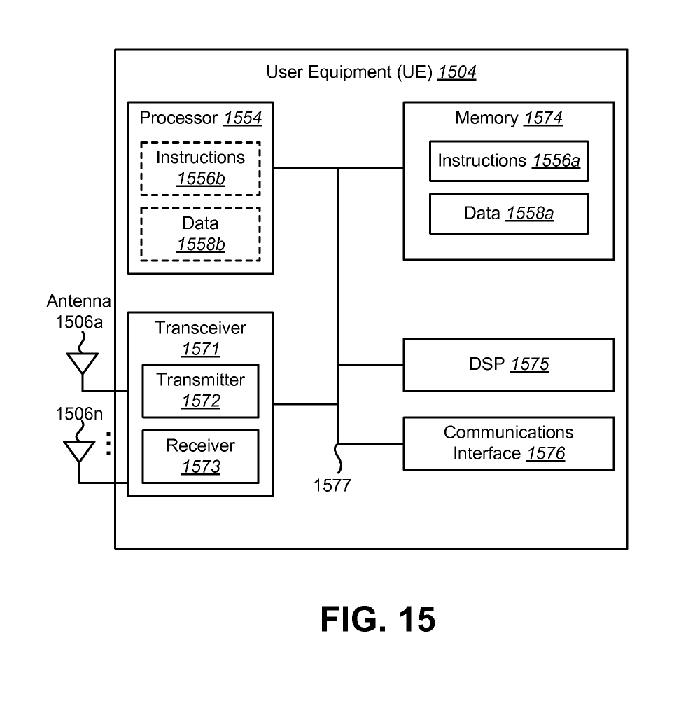

FIG. 15 illustrates various components that may be utilized in a user equipment (UE) 1504. The user equipment (UE) 1504 may be utilized as the user equipment (UE) 104 illustrated previously. The user equipment (UE) 1504 includes a processor 1554 that controls operation of the UE 1504. The processor 1554 may also be referred to as a CPU. Memory 1574, which may include both read-only memory (ROM), random access memory (RAM) or any type of device that may store information, provides instructions 1556a and data 1558a to the processor 1554. A portion of the memory 1574 may also include non-volatile random access memory (NVRAM). Instructions 1556b and data 1558b may also reside in the processor 1554. Instructions 1556b and/or data 1558b loaded into the processor 1554 may also include instructions 1556a and/or data 1558a from memory 1574 that were loaded for execution or processing by the processor 1554. The instructions 1556b may be executed by the processor 1554 to implement the systems and methods disclosed herein.

The user equipment (UE) 1504 may also include a housing that contains a transmitter 1572 and a receiver 1573 to allow transmission and reception of data. The transmitter 1572 and receiver 1573 may be combined into a transceiver 1571. One or more antennas 1506a-n are attached to the housing and electrically coupled to the transceiver 1571.

The various components of the user equipment (UE) 1504 are coupled together by a bus system 1577 which may include a power bus, a control signal bus, and a status signal bus, in addition to a data bus. However, for the sake of clarity, the various buses are illustrated in FIG. 15 as the bus system 1577. The user equipment (UE) 1504 may also include a digital signal processor (DSP) 1575 for use in processing signals. The user equipment (UE) 1504 may also include a communications interface 1576 that provides user access to the functions of the user equipment (UE) 1504. The user equipment (UE) 1504 illustrated in FIG. 15 is a functional block diagram rather than a listing of specific components.

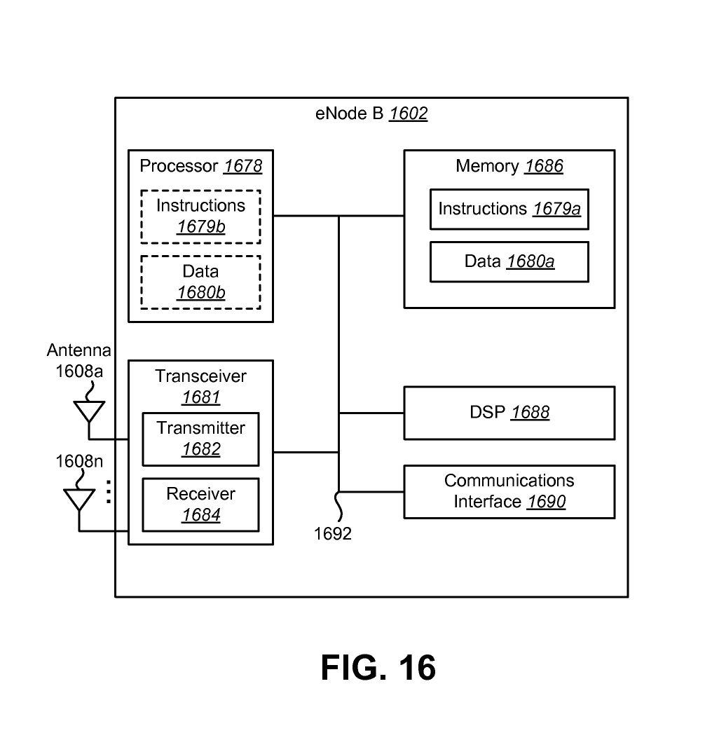

FIG. 16 illustrates various components that may be utilized in an eNode B 1602. The eNode B 1602 may be utilized as the eNode B 102 illustrated previously. The eNode B 1602 may include components that are similar to the components discussed above in relation to the user equipment (UE) 1504, including a processor 1678, memory 1686 that provides instructions 1679a and data 1680a to the processor 1678, instructions 1679b and data 1680b that may reside in or be loaded into the processor 1678, a housing that contains a transmitter 1682 and a receiver 1684 (which may be combined into a transceiver 1681), one or more antennas 1608a-n electrically coupled to the transceiver 1681, a bus system 1692, a DSP 1688 for use in processing signals, a communications interface 1690 and so forth.

Unless otherwise noted, the use of ‘/’ above represents the phrase “and/or”.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio, and microwave, then the coaxial cable, fiber optic cable, twisted pair, DSL, or wireless technologies such as infrared, radio and microwave are included in the definition of transmission medium.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for reporting uplink control information (UCI) on a user equipment (UE), comprising:
monitoring a set of physical downlink control channel (PDCCH) candidates on an activated serving cell;
detecting a PDCCH of a serving cell intended for the UE in a subframe;
decoding a physical downlink shared channel (PDSCH) corresponding to the PDCCH in the same subframe; and
adjusting transmission of the UCI for a subframe corresponding to the subframe in which the PDCCH is decoded.

2. The method of claim 1, wherein the PDCCH detected has a downlink control information (DCI) Format of 1/1A/1B/1C/1D/2/2A/2B/2C.

3. The method of claim 1, wherein adjusting transmission of the UCI comprises switching between simultaneous physical uplink control channel (PUCCH) and physical uplink shared channel (PUSCH) transmissions and non-simultaneous PUCCH and PUSCH transmissions.

4. The method of claim 3, wherein simultaneous PUCCH and PUSCH is configured, and further comprising determining whether the UE is transmitting on the PUSCH for the subframe.

5. The method of claim 4, wherein the UE is not transmitting on the PUSCH for the subframe, and further comprising transmitting the UCI on the PUCCH for the subframe.

6. The method of claim 4, wherein the UE is transmitting on the PUSCH for the subframe, and further comprising determining whether a PDCCH with downlink control information (DCI) Format 0 was detected in a common search space.

7. The method of claim 6, wherein a PDCCH with DCI Format 0 was detected in the common search space, and further comprising transmitting the UCI on the PUSCH for the subframe.

8. The method of claim 6, wherein a PDCCH with DCI Format 0 was not detected in the common search space, and further comprising transmitting the UCI on the PUCCH for the subframe.

9. The method of claim 6, wherein a PDCCH with DCI Format 0 was not detected in the common search space, and further comprising transmitting the UCI on the PUCCH and the PUSCH simultaneously for the subframe.

10. The method of claim 4, wherein the UE is monitoring a set of PDCCH candidates on multiple serving cells, wherein determining whether the UE is transmitting on the PUSCH for the subframe comprises determining whether the UE is transmitting on the PUSCH for the subframe, wherein the UE is not transmitting on the PUSCH for the subframe, and further comprising transmitting the UCI on the PUCCH for the subframe.

11. The method of claim 4, wherein the UE is monitoring a set of PDCCH candidates on multiple serving cells, wherein determining whether the UE is transmitting on the PUSCH for the subframe comprises determining whether the UE is transmitting on the PUSCH for the subframe, wherein the UE is transmitting on the PUSCH for the subframe, and further comprising transmitting the UCI on the PUCCH and the PUSCH simultaneously for the subframe.

12. The method of claim 4, wherein the UE is monitoring a set of PDCCH candidates on multiple serving cells, wherein determining whether the UE is transmitting on the PUSCH for the subframe comprises determining whether the UE is transmitting on the PUSCH for the subframe, wherein the UE is not transmitting on the PUSCH for the subframe, and further comprising determining whether a PDCCH with downlink control information (DCI) Format 0 was detected in a common search space.

13. The method of claim 12, wherein a PDCCH with DCI Format 0 was detected in the common search space, and further comprising transmitting the UCI on the PUCCH for the subframe.

14. The method of claim 12, wherein a PDCCH with DCI Format 0 was not detected in the common search space, and further comprising determining whether the UE is transmitting a hybrid automatic repeat request with discontinuous transmission (HARQ-ACK) corresponding to a physical downlink shared channel (PDSCH) on a secondary cell.

15. The method of claim 14, wherein the UE is transmitting an HARQ-ACK corresponding to the PDSCH on a secondary cell, and further comprising transmitting the UCI on the PUCCH for the subframe.

16. The method of claim 14, wherein the UE is not transmitting an HARQ-ACK corresponding to the PDSCH on a secondary cell, and further comprising transmitting the UCI on the PUSCH for the subframe.

17. The method of claim 4, wherein the UE is monitoring a set of PDCCH candidates on multiple serving cells, wherein determining whether the UE is transmitting on the PUSCH for the subframe comprises determining whether the UE is transmitting on the PUSCH for the subframe, wherein the UE is not transmitting on the PUSCH for the subframe, and further comprising determining whether the UE is transmitting a hybrid automatic repeat request with discontinuous transmission (HARQ-ACK) corresponding to a physical downlink shared channel (PDSCH) on a secondary cell.

18. The method of claim 17, wherein the UE is transmitting an HARQ-ACK corresponding to the PDSCH on a secondary cell, and further comprising transmitting the UCI on the PUCCH for the subframe.

19. The method of claim 17, wherein the UE is not transmitting an HARQ-ACK corresponding to the PDSCH on a secondary cell, and further comprising transmitting the UCI on the PUSCH for the subframe.

20. The method of claim 4, wherein the UE is monitoring a set of PDCCH candidates on multiple serving cells, wherein determining whether the UE is transmitting on the PUSCH for the subframe comprises determining whether the UE is transmitting on the PUSCH for the subframe, wherein the UE is not transmitting on the PUSCH for the subframe, and further comprising determining whether the UE is transmitting on the PUSCH on a secondary cell.

21. The method of claim 20, wherein the UE is transmitting on the PUSCH on a secondary cell, and further comprising transmitting the UCI on the PUCCH for the subframe.

22. The method of claim 20, wherein the UE is not transmitting on the PUSCH on a secondary cell, and further comprising transmitting the UCI on the PUSCH for the subframe.

23. The method of claim 4, wherein the UE is monitoring a set of PDCCH candidates on multiple serving cells, wherein the UE is not transmitting on the PUSCH for the subframe, and further comprising determining whether the UE is transmitting on the PUSCHs on more than one serving cell.

24. The method of claim 23, wherein the UE is transmitting on the PUSCHs on more than one serving cell, and further comprising transmitting the UCI on the PUCCH for the subframe.

25. The method of claim 23, wherein the UE is not transmitting on the PUSCHs on more than one serving cell, and further comprising transmitting the UCI on the PUSCH for the subframe.

26. A user equipment (UE) configured for reporting uplink control information (UCI), comprising:
a processor;
memory in electronic communication with the processor;
instructions stored in the memory, the instructions being executable to:
monitor a set of physical downlink control channel (PDCCH) candidates on an activated serving cell;
detect a PDCCH of a serving cell intended for the UE in a subframe;
decode a physical downlink shared channel (PDSCH) corresponding to the PDCCH in the same subframe; and
adjust transmission of the UCI for a subframe corresponding to the subframe in which the PDCCH is decoded.

27. The UE of claim 26, wherein the PDCCH detected has a downlink control information (DCI) Format of 1/1A/1B/1C/1D/2/2A/2B/2C.

28. The UE of claim 26, wherein adjusting transmission of the UCI comprises switching between simultaneous physical uplink control channel (PUCCH) and physical uplink shared channel (PUSCH) transmissions and non-simultaneous PUCCH and PUSCH transmissions.

29. The UE of claim 28, wherein simultaneous PUCCH and PUSCH is configured, and wherein the instructions are further executable to determine whether the UE is transmitting on the PUSCH for the subframe.

30. The UE of claim 29, wherein the UE is not transmitting on the PUSCH for the subframe, and wherein the instructions are further executable to transmit the UCI on the PUCCH for the subframe.

31. The UE of claim 29, wherein the UE is transmitting on the PUSCH for the subframe, and wherein the instructions are further executable to determine whether a PDCCH with downlink control information (DCI) Format 0 was detected in a common search space.

32. The UE of claim 31, wherein a PDCCH with DCI Format 0 was detected in the common search space, and wherein the instructions are further executable to transmit the UCI on the PUSCH for the subframe.

33. The UE of claim 31, wherein a PDCCH with DCI Format 0 was not detected in the common search space, and wherein the instructions are further executable to transmit the UCI on the PUCCH for the subframe.

34. The UE of claim 31, wherein a PDCCH with DCI Format 0 was not detected in the common search space, and wherein the instructions are further executable to transmit the UCI on the PUCCH and the PUSCH simultaneously for the subframe.

35. The UE of claim 29, wherein the UE is monitoring a set of PDCCH candidates on multiple serving cells, wherein determining whether the UE is transmitting on the PUSCH for the subframe comprises determining whether the UE is transmitting on the PUSCH for the subframe, wherein the UE is not transmitting on the PUSCH for the subframe, and wherein the instructions are further executable to transmit the UCI on the PUCCH for the subframe.

36. The UE of claim 29, wherein the UE is monitoring a set of PDCCH candidates on multiple serving cells, wherein determining whether the UE is transmitting on the PUSCH for the subframe comprises determining whether the UE is transmitting on the PUSCH for the subframe, wherein the UE is transmitting on the PUSCH for the subframe, and wherein the instructions are further executable to transmit the UCI on the PUCCH and the PUSCH simultaneously for the subframe.

37. The UE of claim 29, wherein the UE is monitoring a set of PDCCH candidates on multiple serving cells, wherein determining whether the UE is transmitting on the PUSCH for the subframe comprises determining whether the UE is transmitting on the PUSCH for the subframe, wherein the UE is not transmitting on the PUSCH for the subframe, and wherein the instructions are further executable to determine whether a PDCCH with downlink control information (DCI) Format 0 was detected in a common search space.

38. The UE of claim 37, wherein a PDCCH with DCI Format 0 was detected in the common search space, and wherein the instructions are further executable to transmit the UCI on the PUCCH for the subframe.

39. The UE of claim 37, wherein a PDCCH with DCI Format 0 was not detected in the common search space, and wherein the instructions are further executable to determine whether the UE is transmitting a hybrid automatic repeat request with discontinuous transmission (HARQ-ACK) corresponding to a physical downlink shared channel (PDSCH) on a secondary cell.

40. The UE of claim 39, wherein the UE is transmitting an HARQ-ACK corresponding to the PDSCH on a secondary cell, and wherein the instructions are further executable to transmit the UCI on the PUCCH for the subframe.

41. The UE of claim 39, wherein the UE is not transmitting an HARQ-ACK corresponding to the PDSCH on a secondary cell, and wherein the instructions are further executable to transmit the UCI on the PUSCH for the subframe.

42. The UE of claim 29, wherein the UE is monitoring a set of PDCCH candidates on multiple serving cells, wherein determining whether the UE is transmitting on the PUSCH for the subframe comprises determining whether the UE is transmitting on the PUSCH for the subframe, wherein the UE is not transmitting on the PUSCH for the subframe, and wherein the instructions are further executable to determine whether the UE is transmitting a hybrid automatic repeat request with discontinuous transmission (HARQ-ACK) corresponding to a physical downlink shared channel (PDSCH) on a secondary cell.

43. The UE of claim 42, wherein the UE is transmitting an HARQ-ACK corresponding to the PDSCH on a secondary cell, and wherein the instructions are further executable to transmit the UCI on the PUCCH for the subframe.

44. The UE of claim 42, wherein the UE is not transmitting an HARQ-ACK corresponding to the PDSCH on a secondary cell, and wherein the instructions are further executable to transmit the UCI on the PUSCH for the subframe.

45. The UE of claim 29, wherein the UE is monitoring a set of PDCCH candidates on multiple serving cells, wherein determining whether the UE is transmitting on the PUSCH for the subframe comprises determining whether the UE is transmitting on the PUSCH for the subframe, wherein the UE is not transmitting on the PUSCH for the subframe, and wherein the instructions are further executable to determine whether the UE is transmitting on the PUSCH on a secondary cell.

46. The UE of claim 45, wherein the UE is transmitting on the PUSCH on a secondary cell, and wherein the instructions are further executable to transmit the UCI on the PUCCH for the subframe.

47. The UE of claim 45, wherein the UE is not transmitting on the PUSCH on a secondary cell, and wherein the instructions are further executable to transmit the UCI on the PUSCH for the subframe.

48. The UE of claim 29, wherein the UE is monitoring a set of PDCCH candidates on multiple serving cells, wherein the UE is not transmitting on the PUSCH for the subframe, and wherein the instructions are further executable to determine whether the UE is transmitting on the PUSCHs on more than one serving cell.

49. The UE of claim 48, wherein the UE is transmitting on the PUSCHs on more than one serving cell, and wherein the instructions are further executable to transmit the UCI on the PUCCH for the subframe.

50. The UE of claim 48, wherein the UE is not transmitting on the PUSCHs on more than one serving cell, and wherein the instructions are further executable to transmit the UCI on the PUSCH for the subframe.
